(19) United States
(12) Patent Application Publication
(10) Pub. No.: US 2025/0269567 A1
(43) Pub. Date: Aug. 28, 2025

(54) LIGHTWEIGHT REINFORCED THERMOPLASTIC COMPOSITE ARTICLES WITH A PRINTABLE SURFACE AND METHODS AND SYSTEMS OF PRODUCING THEM

(71) Applicant: HANWHA AZDEL, INC., Forest, VA (US)

(72) Inventors: Liqing Wei, Forest, VA (US); Shriram Joshi, Forest, VA (US); Ruomiao Wang, Forest, VA (US)

(21) Appl. No.: 19/060,236

(22) Filed: Feb. 21, 2025

Related U.S. Application Data
(60) Provisional application No. 63/557,116, filed on Feb. 23, 2024.

(51) Int. Cl. B29C 39/12; B29C 39/38; B29C 39/40; B29K 23/00; B29K 67/00; B29K 105/00; B29K 105/04

(52) U.S. Cl. CPC B29C 39/123; B29C 39/38; B29C 39/405; B29K 2023/00; B29K 2067/00; B29K 2105/0073; B29K 2105/04; B29K 2995/002

(57) ABSTRACT

Certain configurations of systems and methods to print a decorative design on a surface of a lightweight reinforced thermoplastic article are described. In certain instances, the lightweight reinforced thermoplastic article can include a printable surface designed to receive ink or other colorants.

### PRIORITY APPLICATION

This application claims priority to U.S. Provisional Application No. 63/557,116 filed on Feb. 23, 2024, the entire disclosure of which is hereby incorporated herein by reference.

### TECHNOLOGICAL FIELD

Certain configurations are described of lightweight reinforced thermoplastic composite articles which include a printable surface or can be rendered to include a printable surface. In some instances, a design can be printed onto a printable surface. Systems and methods to print designs on the surface in an in-line process are also described.

### BACKGROUND

Lightweight reinforced thermoplastic (LWRT) composite articles can be used in various applications. LWRT composite articles are typically produced without any designs or patterns on the surface of the LWRT composite articles.

### SUMMARY

Certain aspects are described of LWRT composite articles that can include a printable surface. As noted in more detail below, a user selected design can be printed onto the surface in an automated manner during production of the LWRT composite article or post-production of the LWRT composite article. Alternatively, a printed design can be printed onto a printable surface of a skin, e.g., a film or other layer, prior to use of the skin, and the resulting skin with printed design can be used in an in-line process to provide a LWRT composite article. Systems and methods of producing LWRT composite articles with a printable surface are also described.

In an aspect, an in-line process of producing a thermoplastic composite article using an in-line system comprises combining reinforcing materials and a thermoplastic material in an aqueous solution, disposing the aqueous solution with the combined reinforcing materials and the thermoplastic material onto a moving support, removing water from the disposed aqueous solution on the moving support to form a web comprising open cell structures formed from the reinforcing materials and the thermoplastic material, drying the web on the moving support to provide a porous core layer, heating the dried, porous core layer on the moving support to melt the thermoplastic material of the heated, porous core layer, disposing a first skin layer on a first surface of the heated, porous core layer on the moving support, wherein the first skin layer comprises a printable surface, and applying pressure to the heated, porous core layer comprising the disposed first skin layer to provide the thermoplastic composite article.

In certain embodiments, the process comprises printing a design onto the printable surface of the disposed first skin layer. In other embodiments, the process comprises disposing a second skin layer on a second surface of the heated, porous core layer on the moving support. In some embodiments, the process adding a lofting agent to the aqueous solution with the combined reinforcing materials and the thermoplastic material. In other embodiments, the process comprises configuring the first skin layer as a film layer. For examples, the film layer can include reinforcement and/or can include one or more of a polyolefin and a polyester. In certain embodiments, the thermoplastic material comprises a polyolefin and the reinforcing materials comprise inorganic fibers. In some embodiments, the printing comprises printing the design using a digital image and a digital printer. In other embodiments, the process comprises curing the printed design.

In another aspect, an in-line process of producing a thermoplastic composite article using an in-line system comprises combining reinforcing materials and a thermoplastic material in an aqueous solution, disposing the aqueous solution with the combined reinforcing materials and the thermoplastic material onto a moving support, removing water from the disposed aqueous solution on the moving support to form a web comprising open cell structures formed from the reinforcing materials and the thermoplastic material, drying the web on the moving support to provide a porous core layer, heating the dried, porous core layer on the moving support to melt the thermoplastic material of the heated, porous core layer, disposing a first skin layer on a first surface of the heated, porous core layer on the moving support, wherein the first skin layer comprises a printable surface, and printing a design onto the printable surface of the first skin layer to provide the thermoplastic composite article.

In certain embodiments, the process comprises disposing a second skin layer on a second surface of the heated, porous core layer on the moving support. In other embodiments, the process comprises adding a foam to the aqueous solution with the combined reinforcing materials and the thermoplastic material. In some embodiments, the process comprises adding a lofting agent to the aqueous solution with the combined reinforcing materials and the thermoplastic material. In some examples, the process comprises configuring the first skin layer as a film layer. In certain embodiments, the film layer comprises reinforcement. In other embodiments, the film layer comprises one or more of a polyolefin and a polyester. In some configurations, the thermoplastic material comprises a polyolefin and the reinforcing materials comprise inorganic fibers. In other configurations, the printing comprises printing the design using a digital image and a digital printer. In some instances, the process comprises curing the printed design.

In an additional aspect, an in-line process of producing a thermoplastic composite article using an in-line system comprises combining reinforcing materials and a thermoplastic material in an aqueous solution, disposing the aqueous solution with the combined reinforcing materials and the thermoplastic material onto a moving support, removing water from the disposed aqueous solution on the moving support to form a web comprising open cell structures formed from the reinforcing materials and the thermoplastic material, drying the web on the moving support to provide a porous core layer, heating the dried, porous core layer on the moving support to melt the thermoplastic material of the heated, porous core layer, disposing a primer on a first surface of the heated, porous core layer to provide a printable surface on the first surface of the heated, porous core layer and applying pressure to the heated, porous core layer with the printable surface to provide the thermoplastic composite article.

In certain configurations, the process comprises printing a design onto the printable surface. In other embodiments, the process comprises disposing a second skin layer on a second surface of the heated, porous core layer on the moving support. In some examples, the primer is effective to reduce porosity of the porous core layer at the printable surface. In other embodiments, the porosity at the printable surface is less than 5% after application of the primer to the porous core layer. In certain embodiments, the primer comprises a polyolefin. In other embodiments, the polyolefin is applied as a powder. In some embodiments, the thermoplastic material comprises a polyolefin and the reinforcing materials comprise inorganic fibers. In certain configurations, printing comprises printing the design using a digital image and a digital printer. In some embodiments, the process comprises curing the printed design.

In another aspect, an in-line process of producing a thermoplastic composite article using an in-line system comprises combining reinforcing materials and a thermoplastic material in an aqueous solution, disposing the aqueous solution with the combined reinforcing materials and the thermoplastic material onto a moving support, removing water from the disposed aqueous solution on the moving support to form a web comprising open cell structures formed from the reinforcing materials and the thermoplastic material, drying the web on the moving support to provide a porous core layer, heating the dried, porous core layer on the moving support to melt the thermoplastic material of the heated, porous core layer, disposing a primer on a first surface of the heated, porous core layer to provide a printable surface on the first surface of the heated, porous core layer, printing a design onto the printable surface, and applying pressure to the porous core layer with the printed design to provide the thermoplastic composite article.

In certain embodiments, the process comprises disposing a second skin layer on a second surface of the heated, porous core layer on the moving support. In some embodiments, the process comprises adding a foam to the aqueous solution with the combined reinforcing materials and the thermoplastic material. In certain embodiments, the primer is effective to reduce porosity of the porous core layer at the printable surface. In some embodiments, the porosity at the printable surface is less than 5% after application of the primer to the porous core layer. In other embodiments, the primer comprises a polyolefin. In certain examples, the polyolefin is applied as a powder. In certain embodiments, the thermoplastic material comprises a polyolefin and the reinforcing materials comprise inorganic fibers. In other embodiments, the printing comprises printing the design using a digital image and a digital inkjet printer. In some embodiments, the process comprises curing the printed design.

In another aspect, an in-line process of producing a thermoplastic composite article using an in-line system comprises combining reinforcing materials and a thermoplastic material in an aqueous solution, disposing the aqueous solution with the combined reinforcing materials and the thermoplastic material onto a moving support, removing water from the disposed aqueous solution on the moving support to form a web comprising open cell structures formed from the reinforcing materials and the thermoplastic material, drying the web on the moving support to provide a porous core layer, heating the dried, porous core layer on the moving support to melt the thermoplastic material of the heated, porous core layer, disposing a first skin layer on a first surface of the heated, porous core layer on the moving support, wherein the first skin layer comprises a printable surface comprising a pre-printed design on the printable surface; and applying pressure to the heated, porous core layer comprising the disposed first skin layer to provide the thermoplastic composite article with the printable surface comprising the pre-printed design on the printable surface.

In certain embodiments, the process comprises disposing a second skin layer on a second surface of the heated, porous core layer on the moving support. In other embodiments, the process comprises adding a foam to the aqueous solution with the combined reinforcing materials and the thermoplastic material. In certain configurations, the process comprises adding a lofting agent to the aqueous solution with the combined reinforcing materials and the thermoplastic material. In some embodiments, the process comprises configuring the first skin layer as a film layer comprising the pre-printed design. In other embodiments, the film layer comprises reinforcement. In some embodiments, the film layer comprises one or more of a polyolefin and a polyester. In other embodiments, the thermoplastic material comprises a polyolefin and the reinforcing materials comprise inorganic fibers. In certain embodiments, the first skin layer is a film layer comprising a biaxial arrangement of reinforcing materials. In other embodiments, the film layer comprises one or more of a polyolefin and a polyester.

In another aspect, an in-line system configured to produce a thermoplastic composite article with a printed design on a surface comprises a fluid reservoir configured to receive an aqueous solution, a thermoplastic material and reinforcing materials, wherein the fluid reservoir is configured to mix the thermoplastic material and the reinforcing materials in the aqueous solution to provide a homogeneous dispersion of the thermoplastic material and the reinforcing materials in the aqueous solution, a moving support fluidically coupled to the fluid reservoir and configured to receive the homogeneous dispersion from the fluid reservoir and retain the homogeneous dispersion on the moving support, a pressure device configured to remove water from the homogeneous dispersion on the moving support to provide a web comprising open cell structures formed from the reinforcing materials and the thermoplastic material, a device configured to dry and heat the web on the moving support to provide a porous core layer on the moving support, a first supply device configured to receive a first skin material, wherein the first supply device is configured to provide the first skin material as a first skin layer onto a first surface of the porous core layer on the moving support, a second supply device configured to receive a second skin material, wherein the second supply device is configured to provide the second skin material as a second skin layer onto a second surface of the porous core layer on the moving support, a consolidating device configured to consolidate the heated, porous core layer with the disposed first skin layer and the disposed second skin layer by applying pressure to the heated, porous core layer, the disposed first skin layer and the disposed second skin layer to provide a substantially planar thermoplastic composite article, a printer configured to print the design onto a surface of the substantially planar thermoplastic composite article, and a processor configured to control the in-line system to provide the substantially planar thermoplastic composite article and print the design onto the surface of the substantially planar thermoplastic composite article.

In certain configurations, the first supply device is configured to receive a roll of the first skin material. In other configurations, the second supply device is configured to receive a roll of the second skin material. In certain embodiments, the in-line system further comprises a device configured to cut the thermoplastic composite article into individual sheets as the thermoplastic composite article exits the moving support. In other embodiments, the system comprises a second heating device positioned after the consolidating device, wherein the second heating device is configured to heat the thermoplastic composite article to increase an overall thickness of the thermoplastic composite after consolidation. In some embodiments, the system comprises a sprayer fluidically coupled to the fluid reservoir, wherein the sprayer is configured to spray the homogeneous dispersion onto the moving support. In other embodiments, the system comprises an adhesive reservoir configured to dispose an adhesive on the second surface of the heated, porous core layer prior to disposing the second skin layer on the second surface of the heated, porous core layer. In certain embodiments, the printer is a digital printer configured to print the design onto the surface of the substantially planar thermoplastic composite article from a digital image. In some embodiments, the printer is a digital printer. In other embodiments, the system comprises a curing station configured to cure the printed design.

In an additional aspect, a recreational vehicle wall panel comprises a first laminated lightweight reinforced thermoplastic composite article comprising a porous core layer, a first skin layer on a first surface of the porous core layer and a patterned second skin layer on a second surface of the porous core layer, a foam layer coupled to the first laminated lightweight reinforced thermoplastic composite article at a first surface of the foam layer, wherein the foam layer is coupled to the first laminated lightweight reinforced thermoplastic composite article through the first skin layer of the first laminated lightweight reinforced thermoplastic composite article so the patterned second skin layer is present on an interior surface of the recreational vehicle wall, a support structure coupled to a second surface of the foam layer at a first surface of the support structure, a second laminated lightweight reinforced thermoplastic composite article coupled to a second surface of the support structure, wherein the second laminated lightweight reinforced thermoplastic composite article comprises a porous core layer, a first skin layer on a first surface of the porous core layer and a second skin layer on a second surface of the porous core layer, wherein the first skin layer comprises a printed design on a surface of the first skin layer, and an exterior panel coupled to the second laminated lightweight reinforced thermoplastic composite article.

In certain embodiments, the exterior panel comprises fiberglass or aluminum. In other embodiments, the support structure comprises tubing or a network. In some configurations, the first skin layer comprises a film layer. In certain arrangements, the porous core layer in the first laminated lightweight reinforced thermoplastic composite article comprises a web comprising open cell structures formed from reinforcing fibers held together by a thermoplastic material. In some embodiments, the porous core layer in the second laminated lightweight reinforced thermoplastic composite article comprises a web comprising open cell structures formed from reinforcing fibers held together by a thermoplastic material. In certain embodiments, the thermoplastic material in each porous core layer independently comprises a polyolefin. In other embodiments, the reinforcing materials in each porous core layer comprise glass fibers. In additional embodiments, the thermoplastic material in each porous core layer is polypropylene. In some embodiments, the printed design corresponds to a digital image.

In another aspect, a recreational vehicle ceiling panel comprises a laminated lightweight reinforced thermoplastic composite article, wherein the second laminated lightweight reinforced thermoplastic composite article comprises a porous core layer, a first skin layer on a first surface of the porous core layer and a second skin layer on a second surface of the porous core layer, wherein the first skin layer comprises a printable surface.

In an additional aspect, a recreational vehicle comprises a roof, side walls coupled to the roof, and a floor coupled to the sidewalls to provide an interior space within the recreational vehicle, wherein at least one of the sidewalls comprises a recreational vehicle wall panel as described herein. In certain embodiments, the recreational vehicle comprises wheels to permit towing of the recreational vehicle.

In another aspect, a thermoplastic composite article comprises a porous core layer comprising a web of open celled structures formed from reinforcing fibers held in place with a thermoplastic material, and a printable skin layer on a surface of the porous core layer, wherein the printable skin layer is effective to receive an ink from a digital printer and retain the received ink on a surface of the printable skin layer to form a printed design on the printable skin layer.

In certain embodiments, the printable skin layer comprises a primer layer disposed on the porous core layer to decrease a porosity of the porous core layer at an interface between the primer layer and the porous core layer. In other embodiments, the composite article comprises a primer layer between the porous core layer and the printable skin layer, wherein the primer layer is effective to reduce porosity at an interface between the porous core layer and the printable skin layer. In some embodiments, the printable skin layer comprises a film layer. In certain embodiments, the film layer comprises reinforcement. In other embodiments, the film layer comprises one or more of a polyolefin and a polyester. In certain configurations, the thermoplastic material comprises a polyolefin and the reinforcing materials comprise inorganic fibers. In other embodiments, the polyolefin is polypropylene and the inorganic fibers are glass fibers. In certain embodiments, the composite article meets a Class A standard or a Class B standard under ASTM E84-23.

Additional aspects, embodiments, configurations and examples are described in more detail below.

### BRIEF DESCRIPTION OF DRAWINGS

Certain configurations of LWRT composite articles including a printable surface are described with reference to the accompanying figures in which:

FIG. 1 is an illustration of a LWRT composite article including a printable surface, in accordance with certain configurations;

FIG. 2 is an illustration of a core layer, in accordance with certain configurations;

FIG. 3 is an illustration of a core layer including a printable surface, in accordance with certain configurations;

FIG. 4 is an illustration of a core layer and a skin layer that provides a printable surface, in accordance with certain configurations;

FIG. 5 is an illustration of a core layer, a skin layer with a printable surface and a protective layer on the skin layer, in accordance with certain configurations;

FIG. 6 is an illustration of a core layer, a first skin layer and a second skin layer with a printable surface, in accordance with certain configurations;

FIG. 7 is an illustration of a core layer, a first skin layer, a second skin layer with a printable surface and a protective layer on the second skin layer, in accordance with certain configurations;

FIG. 8 is an illustration of a first core layer and a second core layer including a printable surface, in accordance with certain configurations;

FIG. 9 is an illustration of a core layer with a printable surface on each side of a core layer, in accordance with certain configurations;

FIG. 10 is an illustration of a core layer with a printable surface on one side of the core layer and a skin layer with a printable surface on another side of a core layer, in accordance with certain configurations;

FIG. 11 is an illustration of a core layer including different materials on a surface of the core layer, in accordance with certain configurations;

FIG. 12A, FIG. 12B, FIG. 12C, FIG. 12D, FIG. 12E, FIG. 12F, FIG. 12G, FIG. 12H, FIG. 12I, FIG. 12J, FIG. 12K, FIG. 12L, FIG. 12M, FIG. 12N and FIG. 12O show different designs that can be printed onto a LWRT composite article, in accordance with certain configurations;

FIG. 13 is an illustration of an inkjet digital printer, in accordance with certain configurations;

FIG. 14 is an illustration of a laser digital printer, in accordance with certain configurations;

FIG. 15 is an illustration of a gravure printer, in accordance with certain configurations;

FIG. 16 is an illustration of a flexo printer, in accordance with certain configurations;

FIG. 17 is a block diagram showing certain steps in producing a LWRT composite article, in accordance with certain configurations;

FIG. 18 is an illustration showing mixing of materials in a mixing tank, in accordance with certain configurations;

FIG. 19 is an illustration showing deposition of materials onto a moving support, in accordance with certain configurations;

FIG. 20 is an illustration showing a moving support, in accordance with certain configurations;

FIG. 21 is an illustration showing a web moving down a moving support, in accordance with certain configurations;

FIG. 22 is an illustration showing formation of a porous core layer, in accordance with certain configurations;

FIG. 23 is an illustration showing removal of water from the moving support to provide a web, in accordance with certain configurations;

FIG. 24 is an illustration of a sprayer that can spray a primer onto a surface of a porous core layer to provide a printable surface, in accordance with certain configurations;

FIG. 25 is an illustration of a printer that can be used to print a design onto a surface of a porous core layer, in accordance with certain configurations;

FIG. 26 is an illustration showing application of a skin layer to a surface of a web or porous core layer, in accordance with certain configurations;

FIG. 27 is an illustration showing printing of a design onto a printable surface of a skin layer, in accordance with certain configurations;

FIG. 28 is an illustration showing spraying of a primer material onto a surface of a skin layer to provide a printable surface, in accordance with certain configurations;

FIG. 29 is an illustration showing application of skins on each side of a web, in accordance with certain configurations;

FIG. 30 is an illustration showing consolidation of a porous core layer with skins, in accordance with certain configurations;

FIG. 31 is another illustration showing consolidation of a porous core layer with skins, in accordance with certain configurations;

FIG. 32 is an illustration showing a curing station, in accordance with certain configurations;

FIG. 33 is an illustration showing cutting and stacking of LWRT composite articles, in accordance with certain configurations;

FIG. 34 is an illustration showing an in-line system with various components to produce a LWRT composite article including a printable surface or a design printed onto a surface, in accordance with certain configurations;

FIG. 35 is an illustration showing an RV wall, in accordance with certain configurations;

FIG. 36 is an illustration showing an RV, in accordance with certain configurations;

FIG. 37 is an illustration showing remote ordering of customized design panels, in accordance with certain configurations;

FIG. 38 is a table showing various tested properties of a LWRT composite article including a core layer and a film layer with a printable surface;

FIG. 39 is an image of the core layer and film including a printable surface;

FIG. 40 is an image showing a printed hexagonal design onto the film surface of a LWRT composite article using digital printing and a UV curable ink;

FIG. 41 is an image showing a stone design printed onto the film surface of a LWRT composite article using digital printing and a UV curable ink;

FIG. 42 is an image showing a repeating geometric design printed onto the film surface of a LWRT composite article using digital printing and a UV curable ink;

FIG. 43 is an image showing a woodgrain design printed onto the film surface of a LWRT composite article using digital printing and a UV curable ink;

FIG. 44 is an image showing an entire digital image printed onto the film surface of a LWRT composite article using digital printing and a UV curable ink;

FIG. 45 is an image of a diamond design printed onto the film surface of a LWRT composite article using digital printing and a UV curable ink;

FIG. 46 is an image of a brick design printed onto the film surface of a LWRT composite article using digital printing and a UV curable ink;

FIG. 47 is an image showing a marble design printed onto the film surface of a LWRT composite article using digital printing and a UV curable ink;

FIG. 48 is an image of a LWRT composite article before printing;

FIG. 49 is an image of two LWRT composite articles, arranged side by side, after printing;

FIG. 50 is a graph showing the sound absorption coefficients of two LWRT composite articles;

FIG. 51 is a graph showing peak load values in a machine direction (left side of each grouping) and a cross-direction (right side of each grouping); and

FIG. 52 is a graph showing stiffness values in a machine direction (left side of each grouping) and a cross-direction (right side of each grouping).

### DETAILED DESCRIPTION

It will be recognized by the person of ordinary skill in the art, given the benefit of this description, that the different layers described herein are not necessarily shown to scale. No material is intended to be required in any one layer unless specifically indicated in the description in connection with that particular configuration. The thicknesses, arrangements and end-uses of the LWRT composite articles may vary. The thickness of the printed design, in particular, has been shown in a distorted and enlarged manner to facilitate a more user friendly description of the technology.

In certain embodiments, the LWRT composite articles with printable surfaces described herein can be used in building applications, as interior panels in residential and commercial applications, in vehicles such as recreational vehicles and for other uses. Recreational vehicles (RVs), including motorhomes and towables, can incorporate light weight glass fiber reinforced thermoplastic composite panels into sidewalls, ceiling, roofing, or flooring parts to reduce the weight. Compared with traditionally used wood composites, i.e. plywood, the polymeric composites provide abundant benefits, such as better durability, being free of formaldehyde, lighter weight for fuel efficiency, improved acoustic performance, water and mold resistant, and flame retardancy, which benefits derive from the high degree of functional integration of glass and the thermoplastic resin matrix. In addition, the presence of the printable surface permits customization of colors and designs on the LWRT composite article surface which can be printed during production of the articles or immediately prior to end use of the LWRT composite articles. In some configurations, reinforcing fibers in the LWRT composite article, e.g., glass fibers, can advantageously impart to the modulus of elasticity of the resin matrix, resulting in property enforcement at a minimal weight increase. The performance of the resultant composite can depend, at least in part, on the core's formulation (fiber/resin ratio), weight per unit area (areal density), panel application thickness, and any functional skin materials.

In certain examples, the LWRT articles with a printable surface can meet desired performance characteristics including flame spread index, smoke developed index, the Federal Motor Vehicle Safety Standard No. 302 (FMVSS 302) burning rates, ASTM E84-23 class ratings, desired peel strengths and/or have desired acoustic properties. For example, the LWRT composite with a printable surface, and/or printed material on the printable surface, can meet a Class A or Class B standard according to ASTM E84-23 standards. ASTM E84-23 shows the fire resistance rating of a material based on its flame spread and smoke development. The standard has three classes: A, B, and C. Table 1 below shows the different classes for the ASTM E84-23 standard.

TABLE 1

| | Flame Spread | Smoke Developed |
|---|---|---|
| Classification | Index (FSI) | Index (SDI) |
| A | 0-25 | 0-450 |
| B | 26-75 | 0-450 |
| C | 76-200 | 0-450 |

In other instances, the LWRT composites with printable surfaces can have a burning rate of less than 4 inches/minute or less than 3.5 inches/minute or less than 3 inches per minute according to the FMVSS 302 standard as amended in 2011 (49 CFR 571.302). FMVSS 302, Flammability of Interior Materials, can be used to determine the burn resistance capabilities of materials used in the occupant compartments of motor vehicles. This test is similar to ASTM D5132-04. A test sample is aligned horizontally and exposed to a small Bunsen burner flame at one edge. The flame is applied for 15 seconds and then pulled away from the sample. The rate of flame travel across the sample is measured between two points. The pass/fail criteria is based on the burn rate across the test sample, with a maximum burn rate of 102 mm per minute (about 4 inches/minute). The standard sample size used is 102-mm×356-mm (approximately 4-in.×14-in.). In certain embodiments, the LWRT composite articles with printable surfaces pass the FMVSS 302 test.

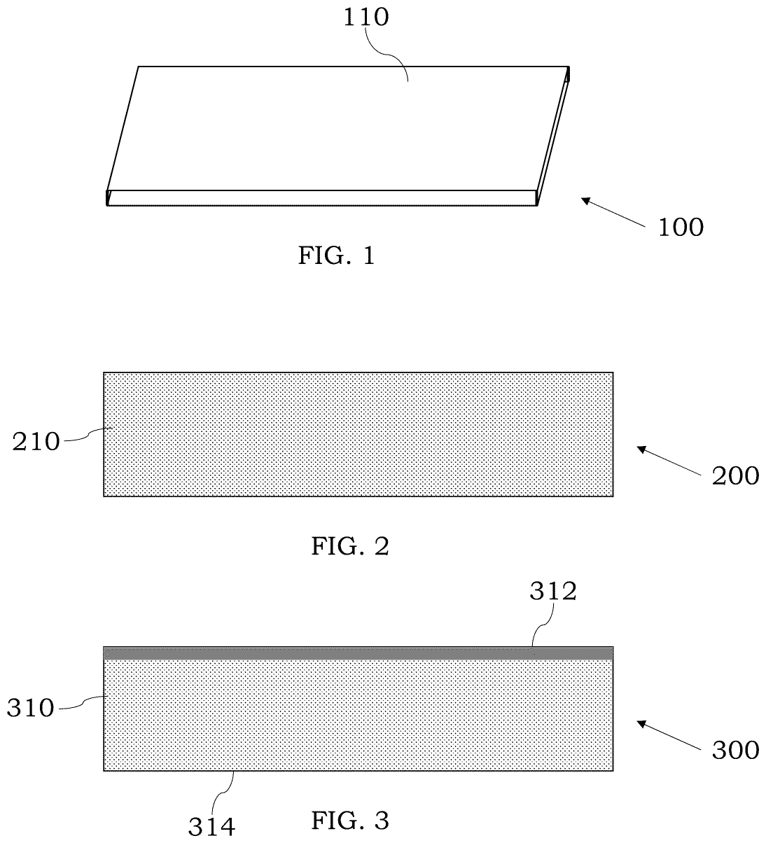

In certain embodiments, the LWRT composite articles described herein include a printable surface. The exact materials used to provide the printable surface may vary depending on the intended material to be printed and/or the methodology used to print onto the surface. Referring to FIG. 1, a LWRT composite article 100 is shown that comprises a printable surface 110. The printable surface can be designed, or can include certain materials, which permits printing of an ink, colorant or other material directly onto the surface 110. In some embodiments, the printable surface is designed to receive a water based ink or colorant, whereas in other configurations the printable surface is designed to receive an oil-based ink or colorant. The exact ink formulation used may vary and can depend, at least in part, on the surface, or materials on the surface, that will receive the ink, the type of printer used, desired cure time, etc. For example, water-based inks offer a more environmentally friendly alternative to solvent-based inks, but the water evaporates at a slower rate compared to solvents. Oil-based inks utilize pigmented systems and can be formulated with non-drying, low volatility oils. UV curable inks produce vibrant, resilient results on uncoated substrates, thereby eliminating the necessity for over-lamination in outdoor and other applications. The LWRT composite article 100 can be porous but may include a reduced level of porosity at the printable surface 110 to facilitate retention of the ink on the printable surface 110. As noted in more detail below, the printable surface 110 may be integral to the underlying core of the LWRT composite article 100 or may be a separate layer or layers that are added to the surface of the core of the LWRT composite article 100. While not shown, if desired the article 100 can include two printable surfaces to provide the same or different designs on each of the printable surfaces. In some embodiments where a separate layer includes a printable surface, the separate layer can be a skin with or without reinforcement. For example, a reinforced film that can include a primer on a printable surface may be used in combination with a core layer to provide a LWRT composite article. The presence of reinforcing resins, chips, materials, whiskers, particles, powders, fibers, etc. in the film can assist in preventing the film from tearing or being deformed during printing of the design onto the film surface. The reinforcing materials may be randomly oriented or oriented in a desired manner as noted in more detail below. Use of lightweight films, e.g., 40 gsm or less, 30 gsm or less or 20 gsm or less, can reduce the overall weight of the LWRT composite article while still permitting designs to be printed onto the LWRT composite article. For example, embossed films may be heavy and thick to permit embossment. The films described herein that include a printable surface may be lighter weight than an embossed film. The lightweight and thin nature of the film with the printable surface may also permit some texture from the underlying core layer to be retained on the surface of the LWRT composite article including the printed design. The film with the printable surface is typically non-porous but may include some porosity, e.g., 5% or less, or have porous areas if desired.

In certain configurations, the LWRT composite articles described herein can be produced using an in-line process and provide a “LWRT blank” which includes a printable surface. Alternatively, the in-line process can include one or more printing stations to print a design onto the printable surface and provide a LWRT composite article with a printed design on at least one surface during production of the LWRT composite article.

In certain embodiments, the LWRT composite articles generally include a core layer which can include a printable surface or a core layer in combination with another layer that provides the printable surface. In some configurations and referring to FIG. 2, a LWRT composite article 200 comprises a core layer 210 that can include a thermoplastic resin material in combination with reinforcing materials. For example, the core layer can be formed from a random arrangement of reinforcing materials that are held in place by the thermoplastic resin material. The reinforcing materials may be reinforcing fibers, whiskers or other materials that can impart some reinforcement to the composite articles. The core layer typically comprises a substantial amount of open cell structure such that void space is present in the core layer. In some instances, the porous core layer may comprise a void content or porosity of 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges. The overall thickness of the core layer 210 may vary from about 1.5 mm to about 15 mm and may change if the core layer 210 is compressed during processing or expanded due to lofting.

In certain embodiments, the thermoplastic material used to form the core layers described herein may include one or more of a polyolefin (e.g., one or more of polyethylene, polypropylene, etc.), polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the core layer can be used in powder form, resin form, rosin form, particle form, fiber form or other suitable forms. Illustrative thermoplastic materials in various forms are described herein and are also described, for example in U.S. Publication Nos. 20130244528 and US20120065283. The exact amount of thermoplastic material present in the core layer can vary and illustrative amounts range from about 20% by weight to about 80% by weight, e.g., 30-70 percent by weight or 35-65 percent by weight, based on the total weight of the core layer. It will be recognized by the skilled person that the weight percentages of all materials used in the core layer will add to 100 weight percent.

In other embodiments, the reinforcing materials of the core layers may comprise glass fibers, carbon fibers, graphite fibers, synthetic organic fibers, particularly high modulus organic fibers such as, for example, para- and meta-aramid fibers, nylon fibers, polyester fibers, a high melt flow index resin (e.g., 100 g/10 min. MFI or above) that is suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In other embodiments, the core layers can include reproduced polymeric fibers, bi-component fibers, e.g., sheath-core fibers, or fibers produced from recycled materials. In some embodiments, any of the aforementioned fibers can be chemically treated prior to use to provide desired functional groups or to impart other physical properties to the fibers, e.g., may be chemically treated so that they can react with the thermoplastic material, the lofting agent or both. The fiber content in the core layers may independently be from about 20% to about 90% by weight of the core layer, more particularly from about 30% to about 70%, by weight of the core layer. The particular size and/or orientation of the fibers used may depend, at least in part, on the thermoplastic material used and/or the desired properties of the core layer. In one non-limiting illustration, fibers dispersed within a thermoplastic material and optionally other additives to provide the core layers can generally have a diameter of greater than about 5 microns, more particularly from about 5 microns to about 22 microns, and a length of from about 5 mm to about 200 mm, more particularly, the fiber diameter may be from about 2 microns to about 22 microns and the fiber length may be from about 5 mm to about 75 mm.

In certain embodiments, other additives may also be present in the mixture comprising the thermoplastic resin and the reinforcing materials. For example, a lofting agent, flame retardants, colorants, smoke suppressants, surfactants, foams or other materials may be present. If desired, recycled materials, biomaterials, bioparticles, ground natural material or other sustainable materials can be included in the core layers. In some examples, the core layer may substantially halogen free or halogen free core layer to meet the restrictions on hazardous substances requirements for certain applications. In other instances, the core layer may comprise a halogenated flame retardant agent such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. In some instances, the thermoplastic material used in the core layers may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant may be present in about 0.1 weight percent to about 15 weight percent (based on the weight of the core layer), more particularly about 1 weight percent to about 13 weight percent, e.g., about 5 weight percent to about 13 weight percent based on the weight of the core layer. If desired, two different halogenated flame retardants may be added to the layers. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the layers may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the layer), more particularly about 1 weight percent to about 13 weight percent, e.g., about 5 weight percent to about 13 weight percent based on the weight of the core layer. If desired, two different substantially halogen free flame retardants may be added to one or more of the core layers described herein. In certain instances, one or more of the core layers described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 20 weight percent (based on the weight of the layer), more particularly about 1 weight percent to about 15 weight percent, e.g., about 2 weight percent to about 14 weight percent based on the weight of the core layer. The flame retardant agents used in the layers described herein can be added to the mixture comprising the thermoplastic material and fibers (prior to disposal of the mixture on a wire screen or other processing component) or can be added after the layer is formed. In some examples, the flame retardant material may comprise one or more of expandable graphite materials, magnesium hydroxide (MDH) and aluminum hydroxide (ATH).

As noted herein, when the core layer comprises a printable surface, the printable surface may have a reduced porosity or no porosity in order to retain the ink or other material on the printable surface. For example and referring to FIG. 3, a LWRT composite article 300 comprises a core layer 310 shown with shading at a surface 312 to represent reduced porosity at the surface 312 compared to a porosity at the surface 314. The reduced porosity can be achieved in many ways including, for example, spraying of material onto the surface, coating or rolling a material onto the surface, dipping the surface into a material or other methodologies. In some embodiments, the porosity at the surface 312 may be below 10%, below 5% or even below 1% to facilitate retention of the printed design on the surface 312 of the core layer 310. In some embodiments, the material added to the surface 312 may be a powder, an alcohol, an acetate, an acrylic or combinations thereof. In some embodiments, the coating can also include pigments, curing agents, salts, surfactants dispersants, crosslinkers or other materials. In certain configurations, the coating can be sprayed onto the surface 312 of the core layer 310 after production or during production of the core layer 310. The coating can function as a primer to facilitate adherence and/or curing of the ink deposited onto the printable surface 312.

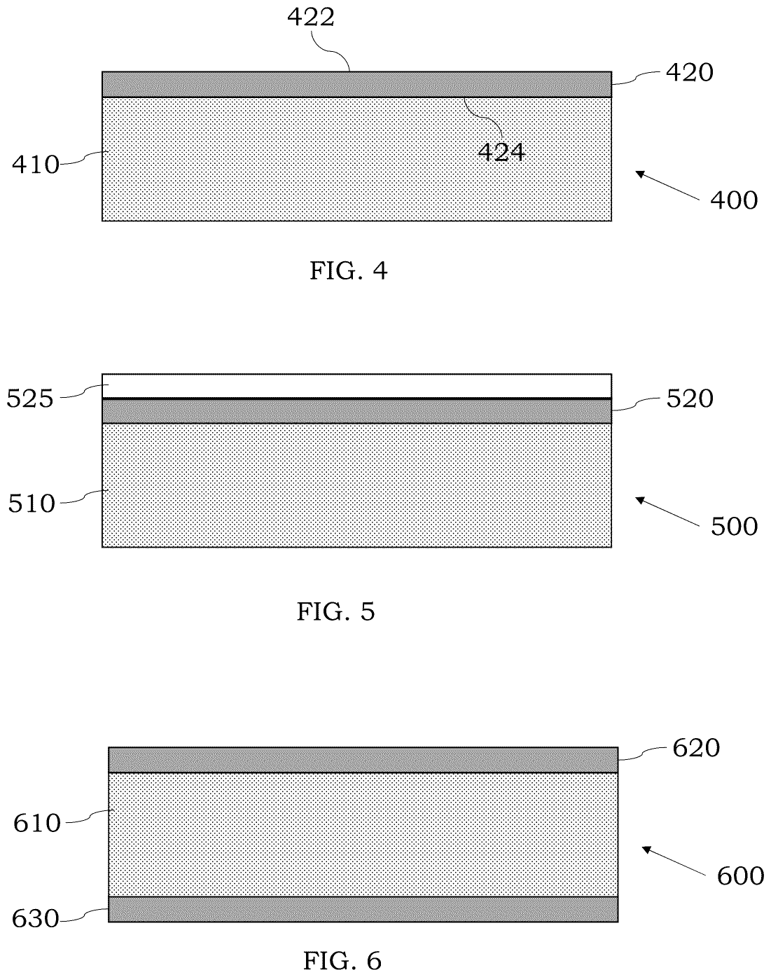

In other embodiments, a separate skin layer can be added to a core layer to provide a printable surface. For example and referring to FIG. 4, a LWRT composite article 400 comprises a skin layer 420 shown as being disposed on a surface of a core layer 410. The skin layer 420 includes a printable surface 422 which can receive an ink or other colorant to provide a design on the surface 422. The skin layer 420 can take numerous forms including films, scrims, frims, paper, another core layer or other arrangements. In some embodiments, the skin layer 420 can include chips, resins, fibers, whiskers, powders, particles or other materials to provide some physical reinforcement to the skin layer 420 and facilitate printing of the ink or colorant onto the surface of the skin layer 420. Where resins, chips or fibers are present in the skin layer 420, the resin, chips or fibers can be randomly arranged, arranged in a single direction, arranged in two or more directions, e.g., biaxially with a 0/90, 0/30, 0/45,0/60 arrangement, etc. where one group of resin, chips or fibers is arranged at an angle relative to the other resin, chips or fibers. For example, in a 0/90 arrangement of fibers, at least one group of fibers are arranged at a 90 degree angle relative to other arranged fibers (the 0 degree fibers used as a reference point). As discussed in more detail below, the skin layer 420 can include one or more materials on a surface or surfaces of the skin layer 420 to facilitate coupling of the skin layer 420 to the core layer 410 and to facilitate receipt of an ink or colorant on the surface 422. In some embodiments, the surface 422 includes a water based primer, an oil based primer or a solvent based primer which can be used to enhance retention of the ink or colorant on the surface and/or cure the deposited ink.

In certain embodiments, the material which is present on the surface of the core layer or the skin to render it printable is referred to in certain instances as a primer. The primer can include suitable materials including but not limited to acrylics, acrylates, alcohols, polyvinyl alcohols, polyvinyl acetates, and similar materials. The primer may be water based or oil based, e.g., solvent based, depending on the nature of the ink or colorant to be deposited. The primer can also include UV curing agents, photoinhibitors, antifading agents or other materials to cure the ink once deposited and/or render the surface color fast in its use environment. If desired, the primers can be free of bisphenol A (BPA) or other bisphenol compounds, such as bisphenol S (BPS). The primer can be coated onto the core layer or skin layer immediately prior to the printing process or can be coated in an inline production process to provide a “blank” which is subsequently used at manufacturer site or point of sale to print an image onto the surface of the LWRT composite article.

In certain configurations, an opposite surface 424 of the skin layer 420 that couples to the core layer 410 can include an adhesive, an alcohol, a polyol, an acetate, an amide, a polyamide, a co-polyamide, a polyolefin or other materials to facilitate coupling of the skin layer 420 to the core layer 410. These materials can be pre-coated onto the skin layer 420 or may be sprayed or otherwise coated on the skin layer 420 during production of the LWRT composite article. The skin layer 420 may take numerous forms including films, scrims, frims, paper, and the like. In some instances, the melting temperature (Tm) of the skin is desirably lower than that of the thermoplastic material used in the core layer to permit softening of the skin during processing of the materials in the inline system and process. The skin layer 420 is typically much less porous than the core layer 410 to facilitate retention of an ink on the skin layer 420. For example, the skin layer 420 may have a porosity of less than 10%, less than 5%, less than 4%, less than 3%, less than 2%, less than 1% or may be non-porous. Where a porous skin layer is used, the primer on the skin layer can act to decrease the overall porosity of the skin layer 420. The skin layer 420 can have a basis weight of about 5 gsm to about 250 gsm, more particularly about 10 gsm to about 30 gsm or about 15 gsm to about 25 gsm. An overall thickness of the skin layer 420 may vary from about 0.01 mm to about 0.3 mm or about 0.02 mm to about 0.08 mm, e.g., about 0.03 mm, 0.04 mm, 0.05 mm, 0.06 mm or 0.07 mm. The skin layer 420 can include a wettability (as measured by ASTM D2578-17) on at least one surface of 30 dynes/cm to 60 dynes/cm or at least 40 dynes/cm or at least 45 dynes/cm.

In certain configurations, the LWRT composite articles can include a protective layer or overcoat on the printable surface. The protective layer is typically added post-printing of the design onto the surface and may act to protect the underlying design from degradation. Referring to FIG. 5, a LWRT composite article 500 is shown that comprises a core layer 510, a first skin layer 520 with a printable surface and a protective layer 525 on the printable surface of the first skin layer 520. In some embodiments, the protective layer 525 is generally transparent to prevent the underlying printed design or pattern to be viewable and may provide some hardness to the finished surface to enhance longevity and/or reduce scratching. The exact materials in the protective layer may vary and can include UV curing agents, light absorption agents, anti-sticking agents or other materials to facilitate protection of the printed ink or increase the overall use lifetime of the LWRT composite article. The exact materials used in the protective layer can depend on the intended use environment of the LWRT composite article. For example, a polyurethane or other hard coating can be applied where the LWRT composite article may receive repeated contact. Color fast agents can be applied to protect the underlying ink from photobleaching or degradation. UV absorption agents may be present to reduce fading of the underlying ink.

In other configurations, an LWRT composite article can include two or more skin layers. Referring to FIG. 6, a LWRT composite article 600 comprises a core layer 610, a first skin layer 620 and a second skin layer 630 on an opposite surface of the core layer 610. The first skin layer 620 and the second skin layer 630 can be the same or different. In some embodiments, the skin layer 620 comprises a printable surface. In other embodiments, the skin layer 630 comprises a printable surface. In other configurations, each of the skin layer 620 and the skin layer 630 comprises a printable surface. The materials on the printable surface of the skin layers 620, 630 can be the same or different. For example, the skin layer 620 may comprise suitable materials for printing of water based inks, whereas the skin layer 630 may comprise suitable materials for printing of oil based inks. As noted above, water based UV curing inks, oil based UV curing inks, solvent-based inks, solvent based UV curing inks or other types of inks could also be used. In a different configurations, each of the skin layers 620, 630 may comprise suitable materials for printing of water based inks. In another configurations, each of the skin layers 620, 630 may comprise suitable materials for printing of oil based inks. In yet another configuration, the skin layer 620 may comprise a printable surface and the skin layer 630 may act to provide structural support to the article 600. For example, the skin layer 630 may comprise a thermoplastic film, a polyolefin film, an elastomer film, etc. In certain configurations, the film comprises at least one of a polyolefin, e.g., polyethylene or polypropylene, at least one poly(ether imide), at least one poly(ether ketone), at least one poly(ether-ether ketone), at least one poly(phenylene sulfide), poly(arylene sulfone), at least one poly(ether sulfone), at least one poly(amide-imide), poly(1,4-phenylene), at least one polycarbonate, at least one nylon, and at least one silicone. In other examples, the skin layer 630 may be, for example, a frim (film+scrim), a scrim (e.g., fiber based scrim), a foil, a woven fabric, a non-woven fabric or be present as an inorganic coating, an organic coating, or a thermoset coating. In other instances, the skin layer 630 may comprise a limiting oxygen index greater than about 22, as measured per ISO 4589 dated 1996. Where a fiber based scrim is present as (or as part of) the other skin layer, the fiber based scrim may comprise at least one of glass fibers, aramid fibers, graphite fibers, carbon fibers, inorganic mineral fibers, metal fibers, metalized synthetic fibers, and metalized inorganic fibers. If desired, the scrim may comprise materials or fibers produced from one or more of the thermoplastic materials described above in connection with the core layers. Where a thermoset coating is present as (or as part of) the skin layer 630, the coating may comprise at least one of unsaturated polyurethanes, vinyl esters, phenolics and epoxies. Where an inorganic coating is present as (or as part of) the skin layer 630, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the skin layer 630, the non-woven fabric may comprise a thermoplastic material, a thermal setting binder, inorganic fibers, metal fibers, metallized inorganic fibers and metallized synthetic fibers. If desired, the skin layer 630 may also comprise a lofting agent, an expandable graphite material, a flame retardant material, bicomponent fibers, biaxially oriented fibers, reproduced fibers, polymeric fibers, natural fibers, natural particles, bioparticles, biofillers, etc.

In certain embodiments, the skin layer 620 can be a film, scrim, frim or other materials which can receive an ink. The skin layer 620 is typically much less porous than the core layer 610 to facilitate retention of an ink on the skin layer 620. For example, the skin layer 620 may have a porosity of less than 10%, less than 5%, less than 4%, less than 3%, less than 2%, less than 1% or may be non-porous. Where a porous skin layer is used, the primer on the skin layer can act to decrease the overall porosity of the skin layer 620. The skin layer 620 typically has a melting point lower than the melting point of the thermoplastic material in the core layer. The skin layer 620 can have a basis weight of about 5 gsm to about 250 gsm, more particularly about 10 gsm to about 30 gsm or about 15 gsm to about 25 gsm. An overall thickness of the skin layer 620 may vary from about 0.01 mm to about 0.3 mm or about 0.02 mm to about 0.08 mm, e.g., about 0.03 mm, 0.04 mm, 0.05 mm, 0.06 mm or 0.07 mm. The skin layer 620 can include a wettability (as measured by ASTM D2578-17) of 30 dynes/cm to 60 dynes/cm or at least 40 dynes/cm or at least 45 dynes/cm. In some embodiments, the skin layer 620 can include a primer material on one side and an adhesive or other material on an opposite side. The side with the primer material remains exposed and can receive the ink or colorant.

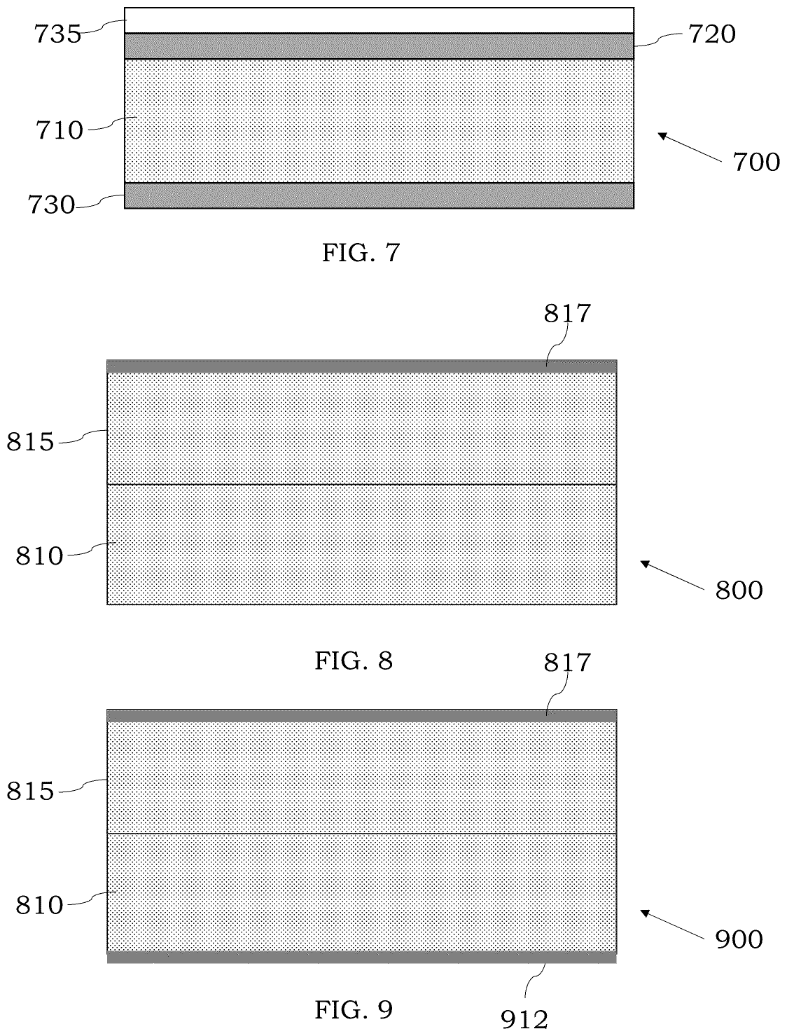

In certain configurations where a LWRT composite article includes two skin layers, one or more additional layers may also be present. Referring to FIG. 7, a LWRT composite article 700 comprises a core layer 710, a first skin layer 720 with a printable surface, a second skin layer 730 and a protective layer 735 on the first skin layer 720. The skin layer 720 typically receives an ink or colorant prior to applying the protective layer 735. However, the skin layer 720 could be prepared in a different process where the ink or colorant is added to the skin layer 720 followed by application of the protective coating layer 735 and optionally curing and/or processing steps. The combined product can then be added to the core layer 720. The skin layer 730 can include a printable surface or may be any of those materials described in reference to skin layer 630 to provide structural support to the LWRT composite article 700. For example, the skin layer 730 may comprise a thermoplastic film, a polyolefin film, an elastomer film, etc. In certain configurations, the film comprises at least one of a polyolefin, e.g., polyethylene or polypropylene, at least one poly(ether imide), at least one poly(ether ketone), at least one poly(ether-ether ketone), at least one poly(phenylene sulfide), poly(arylene sulfone), at least one poly(ether sulfone), at least one poly(amide-imide), poly(1,4-phenylene), at least one polycarbonate, at least one nylon, and at least one silicone. In other examples, the skin layer 730 may be, for example, a frim (film+scrim), a scrim (e.g., fiber based scrim), a foil, a woven fabric, a non-woven fabric or be present as an inorganic coating, an organic coating, or a thermoset coating. In other instances, the skin layer 730 may comprise a limiting oxygen index greater than about 22, as measured per ISO 4589 dated 1996. Where a fiber based scrim is present as (or as part of) the other skin layer, the fiber based scrim may comprise at least one of glass fibers, aramid fibers, graphite fibers, carbon fibers, inorganic mineral fibers, metal fibers, metalized synthetic fibers, and metalized inorganic fibers. If desired, the scrim may comprise materials or fibers produced from one or more of the thermoplastic materials described above in connection with the core layers. Where a thermoset coating is present as (or as part of) the skin layer 730, the coating may comprise at least one of unsaturated polyurethanes, vinyl esters, phenolics and epoxies. Where an inorganic coating is present as (or as part of) the skin layer 630, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the skin layer 730, the non-woven fabric may comprise a thermoplastic material, a thermal setting binder, inorganic fibers, metal fibers, metallized inorganic fibers and metallized synthetic fibers. If desired, the skin layer 730 may also comprise a lofting agent, an expandable graphite material, a flame retardant material, bicomponent fibers, biaxially oriented fibers, reproduced fibers, polymeric fibers, natural fibers, natural particles, bioparticles, biofillers, etc. In instances where the skin layer 730 includes a printable surface, a protective layer or coating (not shown) may also be present to protect any underlying design printed onto the surface of the skin layer 730.

In another embodiments, a LWRT composite article can include two core layers with at least one core layer including a printable surface. Referring to FIG. 8, a LWRT composite article 800 includes a first core layer 810 coupled to second core layer 815 with a printable surface 817 shown as being shaded for illustration purposes and no coating or other material may actually be present on the core layer 815. While the core layers 810, 815 are shown as having substantially the same thickness, this arrangement is not required. Similarly, the core layers 810, 815 need not include the same materials or have the same porosity or basis weight. For example, the core layer 815 may be present as a thin layer, e.g., 0.5-15 mm or 0.5-5 mm or 0.5-3 mm, with low porosity, e.g., 5% or less, and/or have a high basis weight, e.g., 2000 gsm, 2500 gsm, 3000 gsm or more, to enhance retention of the ink or colorant on the surface The core layer 815 can be used as-is or can be sprayed or coated with a water based primer, oil based primer or other materials to facilitate retention of an ink or colorant onto the surface 817. While not shown, a protective layer or other coating can be applied to the printable surface after printing of the design onto the printable surface 817.

Each of the core layers 810, 815 may independently include a thermoplastic resin material in combination with reinforcing materials. For example, each of the core layers 810, 815 can be formed from a random arrangement of reinforcing materials that are held in place by the thermoplastic resin material. The reinforcing materials may be reinforcing fibers, whiskers or other materials that can impart some reinforcement to the composite articles. The core layers 810, 815 typically comprise a substantial amount of open cell structure such that void space is present in the core layer. In some instances, the porous core layers 810, 815 may independent may comprise a void content or porosity of 0-5%, 0-10%, 0-15%, 0-20%, 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95%, 0.1-1%, 0.5-2%, 0.5-3%, 0.5-4%, 0.5-5% or any illustrative value within these exemplary ranges.

In certain embodiments, the thermoplastic material used to form the core layers 810, 815 may independently be a polyolefin (e.g., one or more of polyethylene, polypropylene, etc.), polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the core layer can be used in powder form, resin form, rosin form, particle form, fiber form or other suitable forms. Illustrative thermoplastic materials in various forms are described herein and are also described, for example in U.S. Publication Nos. 20130244528 and US20120065283. The exact amount of thermoplastic material present in the core layer can vary and illustrative amounts range from about 20% by weight to about 80% by weight, e.g., 30-70 percent by weight or 35-65 percent by weight, based on the total weight of the core layer. It will be recognized by the skilled person that the weight percentages of all materials used in each of the core layers 810, 815 will add to 100 weight percent. As noted herein, the core layers 810, 815 need not include the same type or amount of thermoplastic material.

In other embodiments, the reinforcing materials of the core layers 810, 815 may independently comprise glass fibers, carbon fibers, graphite fibers, synthetic organic fibers, particularly high modulus organic fibers such as, for example, para- and meta-aramid fibers, nylon fibers, polyester fibers, a high melt flow index resin (e.g., 100 g/10 min. MFI or above) that is suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In other embodiments, the core layers 810, 815 can independently include reproduced polymeric fibers, bi-component fibers, e.g., sheath-core fibers, or fibers produced from recycled materials. In some embodiments, any of the aforementioned fibers can be chemically treated prior to use to provide desired functional groups or to impart other physical properties to the fibers, e.g., may be chemically treated so that they can react with the thermoplastic material, the lofting agent or both. The fiber content in the core layers 810, 815 may independently be from about 20% to about 90% by weight of the core layer, more particularly from about 30% to about 70%, by weight of the core layer. The particular size and/or orientation of the fibers used may depend, at least in part, on the thermoplastic material used and/or the desired properties of the core layers 810, 815. In one non-limiting illustration, fibers dispersed within a thermoplastic material and optionally other additives to provide the core layers can generally have a diameter of greater than about 5 microns, more particularly from about 5 microns to about 22 microns, and a length of from about 5 mm to about 200 mm, more particularly, the fiber diameter may be from about 2 microns to about 22 microns and the fiber length may be from about 5 mm to about 75 mm. As noted herein, the core layer 810, 815 need not include the same type or amount of reinforcing materials.

In certain embodiments, other additives may also be present in the mixture comprising the thermoplastic resin and the reinforcing materials. For example, a lofting agent, flame retardants, colorants, smoke suppressants, surfactants, foams or other materials may be present. If desired, recycled materials, biomaterials, bioparticles, ground natural material or other sustainable materials can be included in the core layers 810, 815. In some examples, the core layers 810, 815 may substantially halogen free or halogen free core layer to meet the restrictions on hazardous substances requirements for certain applications. In other instances, the core layers 810 815 may comprise a halogenated flame retardant agent such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. In some instances, the thermoplastic material used in the core layers 810, 815 may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant may be present in about 0.1 weight percent to about 15 weight percent (based on the weight of the core layer), more particularly about 1 weight percent to about 13 weight percent, e.g., about 5 weight percent to about 13 weight percent based on the weight of the core layer. If desired, two different halogenated flame retardants may be added to the core layers. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the layers may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the layer), more particularly about 1 weight percent to about 13 weight percent, e.g., about 5 weight percent to about 13 weight percent based on the weight of the core layer. If desired, two different substantially halogen free flame retardants may be added to one or more of the core layers 810, 815. In certain instances, one or more of the core layers 810, 815 described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 20 weight percent (based on the weight of the layer), more particularly about 1 weight percent to about 15 weight percent, e.g., about 2 weight percent to about 14 weight percent based on the weight of the core layer. The flame retardant agents used in the layers described herein can be added to the mixture comprising the thermoplastic material and fibers (prior to disposal of the mixture on a wire screen or other processing component) or can be added after the layer is formed. In some examples, the flame retardant material may comprise one or more of expandable graphite materials, magnesium hydroxide (MDH) and aluminum hydroxide (ATH).

In certain embodiments where two or more core layers are present in an LWRT composite article, each of the core layers can include a printable surface. For example and referring to FIG. 9, a LWRT composite article includes a first core layer 810 with a printable surface 912 and a second core layer 815 with a printable surface 817. The printable surfaces 817, 912 can be designed to receive similar types of inks or colorants, e.g., water based inks or oil based inks, or can be designed to receive different types of inks or colorants. For example, the surface 817 can be designed to receive a water based ink and the surface 912 can be designed to receive an oil based ink. Depending on the particular design and/or ink intended to be deposited, the appropriate printable surface can be selected for use. The non-used surface can be left as-is or can be coupled to another skin layer such as, for example, the skin layers 630, 730 described herein to provide structural support to the LWRT composite article 900. While not shown, a protective layer or coating can be applied to the printable surface 817 or the printable surface 912 after printing of the design onto the printable surface.

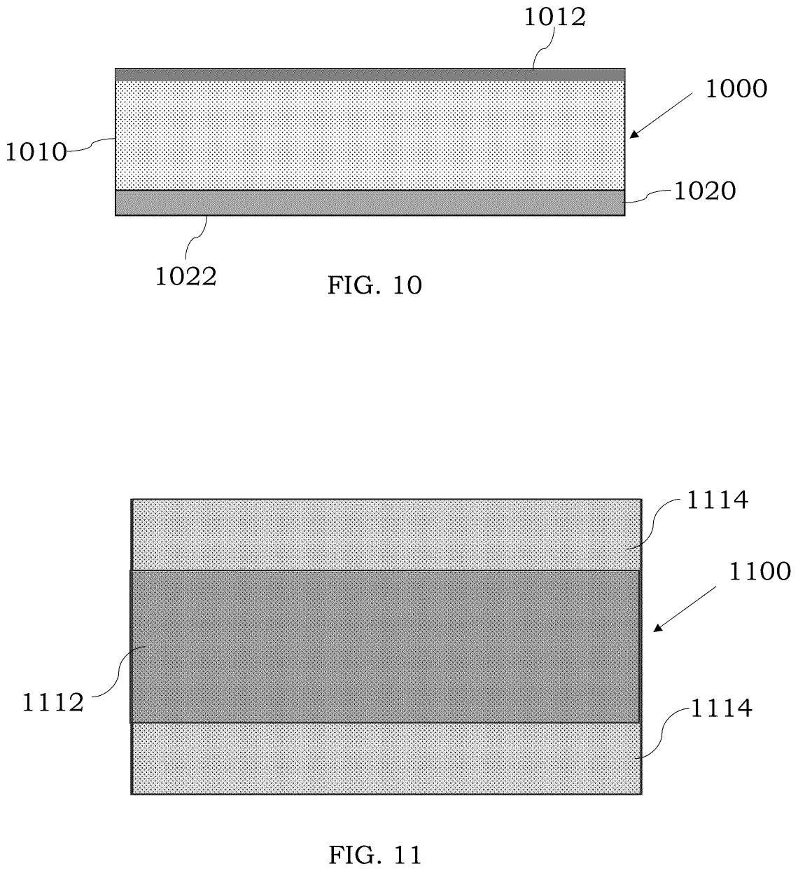

In other configurations, the LWRT composite articles described herein can include a core layer with a printable surface on one side of the core layer and a skin layer with a printable surface on another side of the core layer. Referring to FIG. 10, a LWRT composite article 1000 includes a core layer 1010 with a printable surface 1012 and a skin layer 1020 coupled to the core layer 1010 at an opposite surface from the printable surface 1012. The skin layer 1020 can also include a printable surface 1022. The printable surfaces 1012, 1022 can be designed to receive similar types of inks or colorants, e.g., water based inks, oil based inks, solvent based inks water based UV curing inks, oil based UV curing inks, solvent based UV curing inks, etc., or can be designed to receive different types of inks or colorants. For example, the surface 1012 can be designed to receive a water based ink and the surface 1022 can be designed to receive an oil based ink. Depending on the particular design and/or ink intended to be deposited, the appropriate printable surface can be selected for use. The non-used surface can be left as-is or can be coupled to another skin layer such as, for example, the skin layers 630, 730 described herein to provide structural support to the LWRT composite article 1000. While not shown, a protective layer or coating can be applied to the printable surface 1012 or the printable surface 1022 after printing of the design onto the printable surface.

In certain embodiments, a LWRT composite article can include a core layer with different materials at different areas. Referring to FIG. 11, a top view of a core layer 1100 having a first area 1112 and second areas 1114 on a surface of the core layer. The different areas 1112, 1114 can include different materials or different colors to facilitate printing of a particular design onto the different areas 1112, 1114. In other instances, the areas 1114 may include materials designed to inhibit retention of inks or colorants, whereas the area 1112 can include suitable materials to facilitate retention of inks or colorants. The arrangement shown in FIG. 11 is not critical and the exact size and placement of the different areas 1112, 1114 may vary. For example, the core layer 1100 can include thin strip areas at the edges designed to inhibit retention of inks at the edges to permit different panels to be joined to each other at the edges. Alternatively, the edges can include printable areas to permit printing of border patterns around the edges of the LWRT composite article 1100, and central areas can include materials designed to inhibit ink retention to keep the central areas free from any design. While FIG. 11 shows a core layer 1100 with different areas, a skin layer could likewise include different areas that can facilitate or inhibit retention of inks or colorants at selected areas.

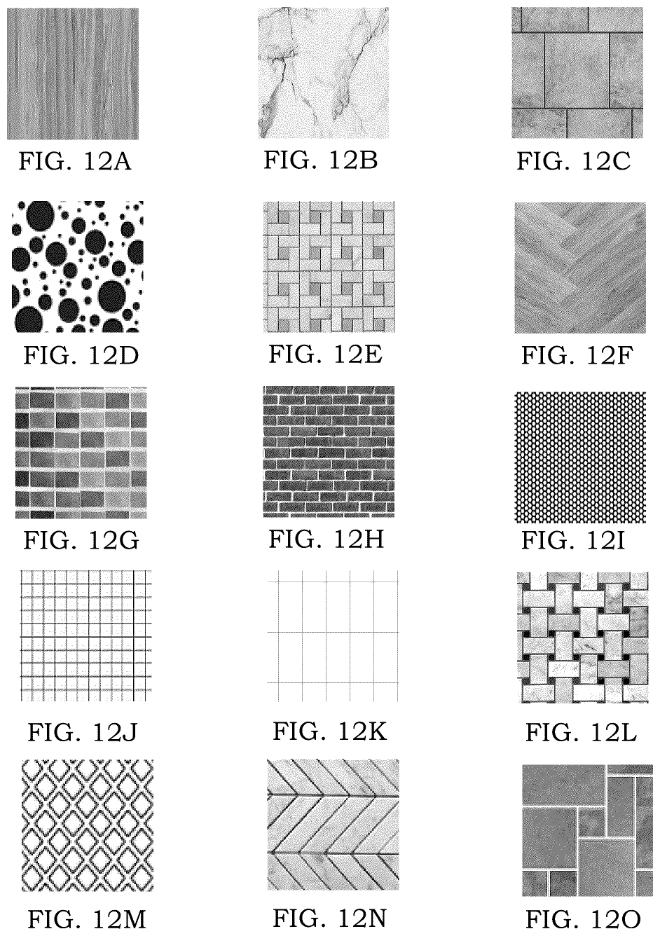

In certain embodiments, the exact design that is printed onto the surface of the LWRT composite articles described herein can include, but is not limited to, a woodgrain design (FIG. 12A), a marble design (FIG. 12B), a tile design (FIG. 12C), a random design (FIG. 12D), a pinwheel design (FIG. 12E), a herringbone design (FIG. 12F), a brick design (FIG. 12G), an offset staggered brick design(FIG. 12H), an offset design (FIG. 12I), a grid design (FIG. 12J), a stacked vertical design (FIG. 12K), a basket weave design (FIG. 12L), a diamond design (FIG. 12M), a chevron design (FIG. 12N) or a French design (FIG. 12O). In addition, designs from graphic images, artistic drawings or other designs can be printed onto the surfaces of the LWRT composite articles. In general, the design is present as an electronic file which is used in combination with a computer and one or more printed devices to print the design onto the surface of the LWRT composite article using a suitable ink or colorant.

In certain embodiments, the printers used in the systems described herein can be designed to implement various printing processes and types depending on the intended design, the number of articles which need printing and other factors. In general, the printer can be designed to implement one or more of screen printing, offset printing, gravure printing, flexo printing or digital printing. Screen printing, also known as silk screening, is a printing technique that involves creating a stencil (or screen) and using it to apply layers of ink onto a substrate through a mesh screen. The areas of the screen that are not part of the stencil block the ink, while the open areas allow the ink to pass through, creating the desired image. Offset printing involves transferring an image from a plate to a rubber blanket cylinder, then onto the printing substrate, resulting in high-quality prints. Gravure printing typically uses a cylinder with a raised image to print on the core layer, the skin layer or both. The printing ink is transferred from the expanded image to the layer, which gives the Gravure printing method its distinct appearance. Gravure printing may be particular useful where large numbers of articles with the same design need to be produced. Flexography, also known as flexo printing, is a printing process that utilizes a flexible relief plate. Flexography involves using an ink roller that transfers the ink to the printing plate. The plate is then wrapped around a cylinder, which prints the image onto the core layer, the skin layer or both. Flexo printing is often used for high quality but low volume printing applications as the printing speed is typically lower than gravure printing or digital printing. Digital printing in general involves the use of a computer and graphic image in combination with one or more inks to transfer the image onto a surface. The exact type of digital printing can vary and includes, but is not limited to, inkjet printing, laser printing (or xerographic printing), solid ink printing, digital press printing, dye printing, etc. Unlike other types of printing, digital printing does not use a printing plate. Instead, the image from the graphic file is reproduced and/or sized by the computer to be placed onto the surface of the core layer, the skin layer or both, using print heads or other suitable non-printing plate means to transfer ink or colorant directly to the surface. Any of these printing methods can be used to print a design onto a surface of a core layer, a skin layer or both. Various heating and/or curing steps may be performed to increase the adherence of the inks or colorants to the surface. Protective layers or coats may also be applied to increase hardness, render the surface color fast or otherwise extend the lifetime of the article.

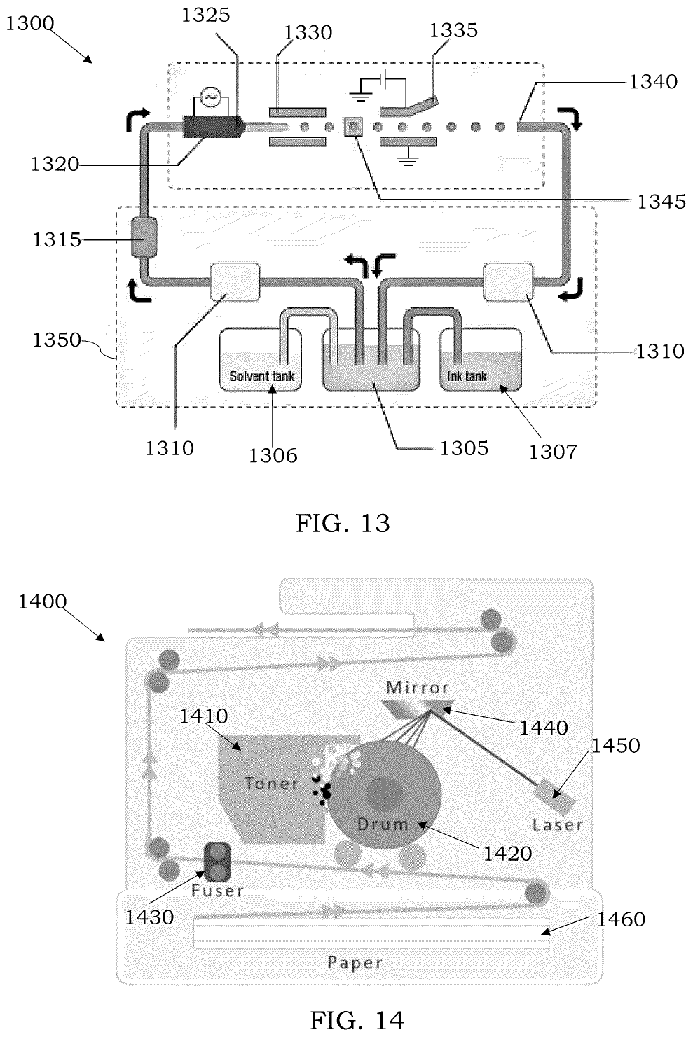

In certain embodiments, the systems and methods described herein can include an inkjet printer that is placed in-line to digitally print a design or pattern onto a skin or a core layer or a core layer including an already placed skin during production of the LWRT composite article. While the exact arrangement of an inkjet printer may vary, a typical inkjet printer arrangement is shown in FIG. 13. The inkjet printer 1300 includes a main tank 1305, a pumps 1310, a decompression valve 1315, a piezo element 1320, a nozzle head 1325, charging electrode plates 1330, deflecting electrodes 1335, a gutter 1340, a charge sensor 1345, and a pump 1340. A controller 1350 is shown as controlling the various components of the system 1300. The piezo element 1320, a nozzle head 1325, charging electrode plates 1330, deflecting electrodes 1335, and gutter 1340 are typically present in a print head. The main tank 1305 stores the ink or inks used in the printing process and is typically fluidically coupled to a solvent tank 1306 and an ink tank 1307. Ink is recovered from the gutter 1340 and returned to the appropriate tank(s). The pump 1310 pressurizes and feed the ink from the main tank 1310 to the print head 1355. Pressure valve 1315 can be present to control the exact pressure of ink provided from the tank 1310 to the print head 1355. The piezo element is used to oscillate the ink stream discharged from the nozzle head 1325 to separate the liquid ink into ink particles. The nozzle head 1325 discharges the ink particles. The charging electrode plates 1330 apply a negative electric charge to the ink particles. The sensor 1345 monitor the particles to ensure they have the proper charge. The deflecting electrodes 1335 generate s magnetic field to deflect the ink particles and direct them onto the surface of the core layer or the skin layer or both. Non-used ink particles are collected by the gutter 1340 and return to the main tank 1305. Control of the system is performed by a processor which is electrically coupled to the various components of the system. General flow of ink through the system is shown using the bold arrows. A particular design to be printed onto the core layer, the skin layer or both can be selected using computer control, and the controller 1350 can control the various components of the system 1300 to deposit ink onto the surface of the core layer, skin layer or both to provide the printed design.

In another configuration, a laser printer (or other type of xerographic printer) can be used to digitally print the design onto a surface of the core layer, the skin layer or both. An illustration of a laser printer 1400 is shown in FIG. 14 and includes a toner cartridge 1410, a drum 1420, a fuser 1430, a mirror 1440 and a laser 1450. The printer 1400 uses the laser 1450 to beam the image to be printed to the mirror 1440 and onto the drum 1420. The drum 1420 uses static electricity to attract powdered toner from the toner cartridge 1410 to the cylinder of the drum 1420. The toner is melted and pressed into the paper 1460 by heat from the fuser 1430 and then the paper 1460 is ejected from the printer 1400. The double headed arrows show movement of the paper through the printer 1400. Similar components can be used to print an image onto a surface of a core layer or a skin layer. Xerography printing conventionally uses “dry” powders and avoids the need for extensive curing times, though curing steps may be performed if desired.

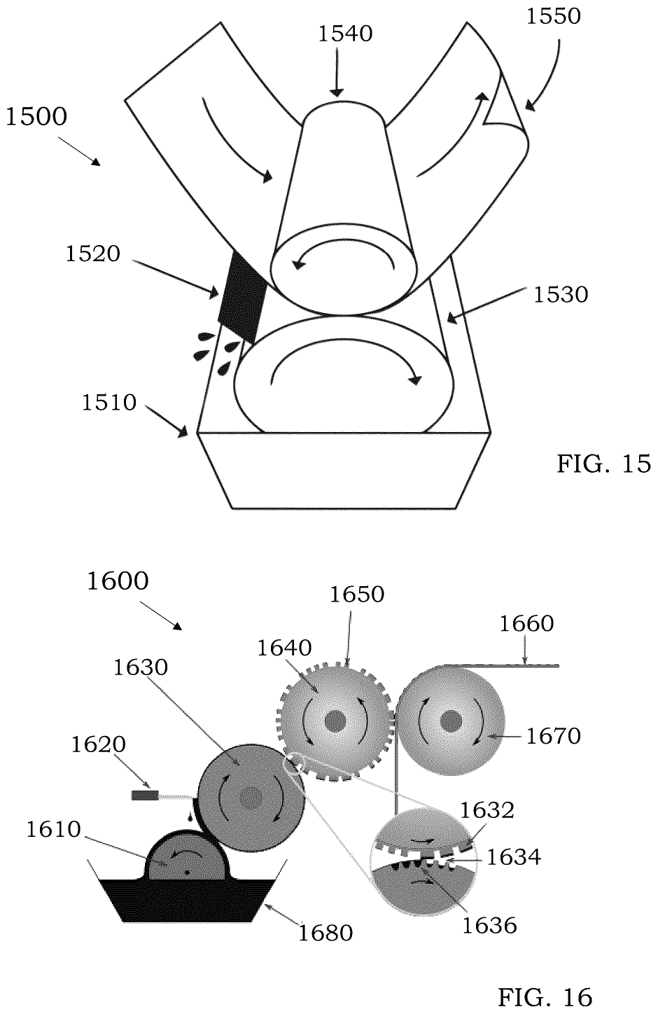

In other configurations, gravure printing can be used to print images onto a surface of a core layer or a skin layer. An illustration of certain components of a gravure printing system are shown in FIG. 15. The system 1500 includes an ink foundation 1510, a doctor blade 1520, a gravure cylinder 1530, and an impression roll 1540 to print a design on a core layer or skin layer 1550. The ink is applied directly to the cylinder 1530 and from the cylinder 1530 it is transferred to the layer 1550. The cylinder 1530 includes the images to be transferred to the layer 1550. The doctor blade 1520 removes excess ink from the cylinder 1530 prior to the layer 1550 being sandwiched between the cylinder 1530 and the impression roll 1540 to transfer the design to the layer 1550.

In another configurations, flexography or flexo printing can be used to print the image onto the core layer or the skin layer. The system 1600 includes a fountain roller 1610, a doctor blade 1620, an anilox roller 1630, a plate cylinder 1640 with a flex plate 1650, an impression cylinder 1670 and an ink tray 1680. The fountain roller 1610 transfers ink to the anilox roller 1630. For example and as shown in the inset, cells 1636 transfer ink 1634 onto the surface 1632 of the flexo plate 1650. The anilox roller 163 transfers a uniform thickness of ink to the flexo plate 1650. The doctor blade 1620 removes excess ink from the anilox roller. The flexo plate 1650 includes the image to be transferred to a substrate 1660 that passes between the flexo plate 1650 and the impression cylinder 1670 to print the image onto the substrate 1660, which can be a core layer or a skin layer.

In certain embodiments, the images which can be printed onto the surface of a core layer or skin layer may vary. In some embodiments, any digital image can be printed onto a surface of a core layer or a skin layer by way of computer control of a digital inkjet printer. Further, different images can be printed at different areas of sites as desired.

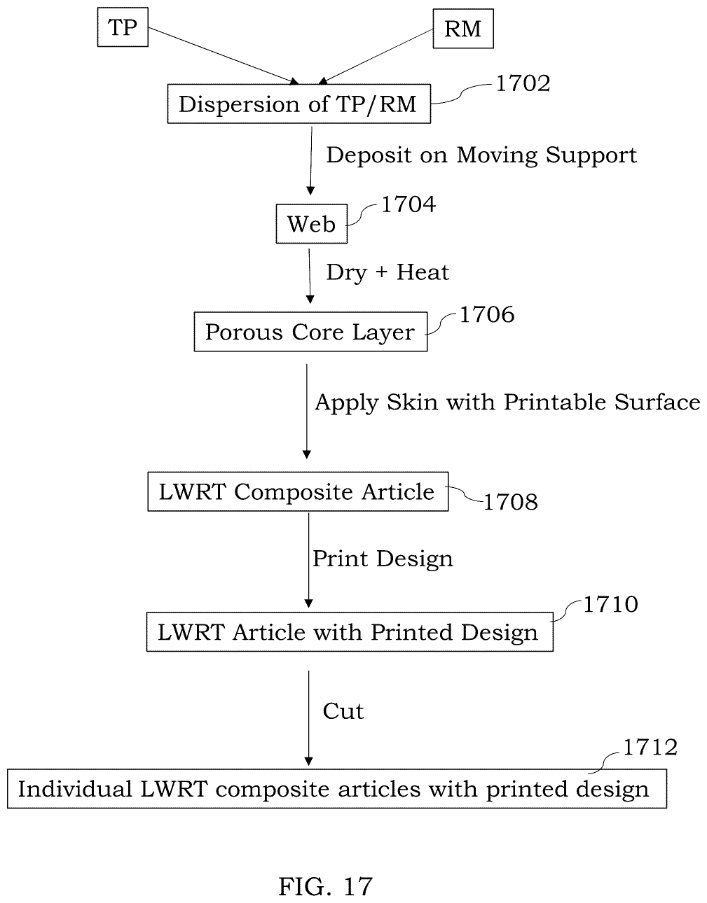

In certain embodiments, an in-line process to produce a LWRT composite article with a printable surface or an LWRT composite article including a skin with a pre-printed design can include numerous steps which are typically controlled in an automated manner using a processor or computer as described in more detail below. Certain steps of the process, and the various materials used/produced by each step, are shown by way of the block diagram in FIG. 17. A core layer is prepared by combining a thermoplastic material (TP, e.g., a thermoplastic resin and reinforcing materials (RM) to form a dispersion or mixture 1702. This mixture can then be deposited onto a suitable moving support to provide a web 1704 formed by the reinforcing materials and the thermoplastic resin. The resulting web can include open cell structures of reinforcing materials, e.g., fibers, held in place by the thermoplastic material. The resulting web can be heated and dried to soften or melt the thermoplastic resin and form a porous core layer 1706. In certain embodiments, a primer material can then be sprayed onto a surface of the porous core layer 1706 to provide a printable surface. In such instances, the skin mentioned below can be omitted. Alternatively, one or more skin layers with a printable surface (or a surface that can be rendered printable) can then be applied to a surface of the formed and heated porous core layer. For example, a film with a printable surface can be applied to form a LWRT composite article 1708. The resulting LWRT composite can be used to print a design onto the printable surface of the skin to provide a LWRT composite article with the printed design. The resulting sheet can be consolidated, if desired, into a flat sheet that can be used in forming interior panels or other articles. For example, the articles 1710 on the moving support can be cut to provide individual LWRT composite articles 1712 which can be stacked or palletized for shipping. Various illustrations of process conditions, steps and materials are described in more detail below.

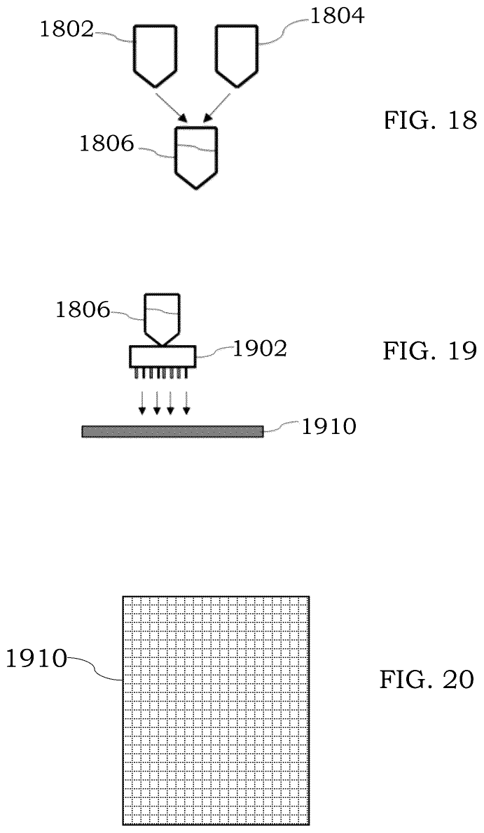

As shown in FIG. 18, a thermoplastic material can be present in a reservoir 1802 and reinforcing fibers (or other reinforcing materials) can be present in a second reservoir 1804. Each of the thermoplastic material and the reinforcing fibers can be metered, sprayed, or otherwise introduced into an aqueous solution in a mixing tank 1806 comprising water, a liquid or an aqueous solution. If desired, a foam or other additives (as discussed below) may be present in the mixing tank 1806. The thermoplastic material and reinforcing fibers can be mixed for a suitable time and at a suitable temperature to provide a substantially homogenous aqueous dispersion of the fibers and the thermoplastic material. For example, the materials may be mixed at room temperature, e.g., about 25 deg. Celsius, or above room temperature or below room temperature by heating or cooling the mixing tank. In some embodiments, the materials can be added continuously into the mixing tank 1806 to permit continuous deposition of the dispersion onto a moving support as noted below. While the exact mixing time may vary depending on the materials used, illustrative mixing times include 10 seconds to about 10 minutes, more particularly about 30 seconds to about 5 minutes. As noted above, however, in instances where the materials are continuously added to the mixing tank 1806, mixing is performed constantly. The mixing tank 1806 can include a paddle mixer, an impeller or other devices to facilitate mixing. Where the produced core layer is intended to be colored, an ink or other colorant can be added to the mixing tank 1806.

In certain embodiments and referring to FIG. 19, the dispersion in the mixing tank 1806 can be sprayed, dripped or otherwise deposited onto a moving support 1910. While the moving support 1910 is shown as a single segment in certain figures depicted herein, the moving support 1910 could be broken up into two or more individual segments as desired. The mixing tank 1806 can be fluidically coupled to a plurality of spray heads 1902 that can spray the dispersion onto a surface of the moving support 1910. As shown in the top view of FIG. 20, the moving support 1910 can be porous or include a mesh that can receive the dispersion. The exact deposition rate used may vary depending on the amount of material to be deposited per square meter. The moving support 1910 may move at a continuous and constant speed to permit continuous spraying of the dispersion along a top surface of the moving support 1910. The area of the moving support 1910 under the spray heads may be heated, cooled or present at room temperature during deposition of the dispersion. As noted below, different areas of the moving support 1910 may have different temperatures. The exact dimensions of the moving support 1910 can vary and typically the moving support is about 4 feet wide and can include a mesh or pore size of about 60 openings/square inch to about 80 openings/square inch of moving support 1910. The moving support 1910 permits receipt of the dispersion and movement of the received dispersion to additional sites or stations of the in-line system. For example, after formation of the core layer on the moving support, a skin with a printable surface can be deposited in an automated manner on a surface of the formed core layer. At the end of the moving support 1910, the formed LWRT composite articles can be cut and stacked. The moving support 1910 permits continuous formation of LWRT composite articles. In certain embodiments, the moving support 1910 can be split into two or more separate sections or segments. For example, a wet mat can be formed on a former belt and then transferred, e.g., manually or automatically, onto a separate dryer belt where it can pass through an oven or other drying device.

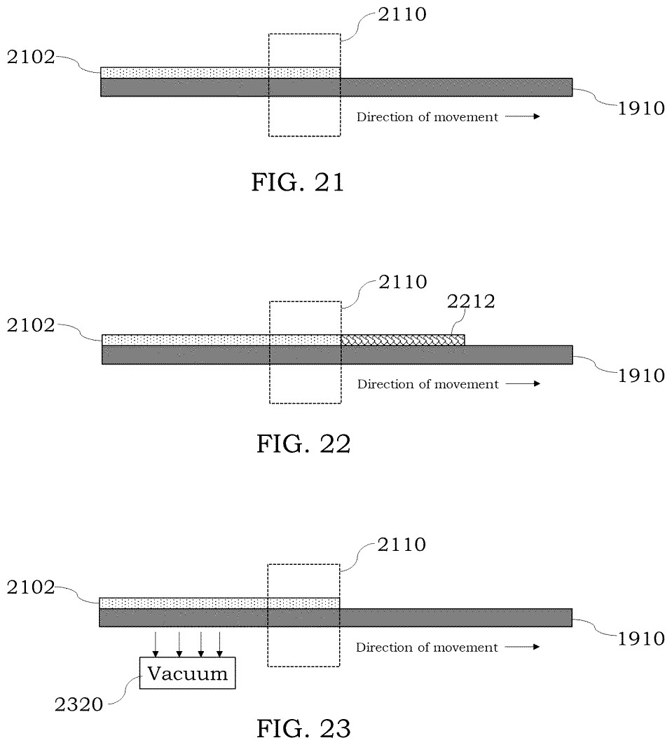

In certain embodiments and referring to FIG. 21, the moving support 1910 with the dispersion of the thermoplastic material and reinforcing fibers can migrate to a drying device 2110. The drying device 2110 can provide heat and/or a negative pressure (vacuum) to remove the water from the web 2102 on the moving support and leave behind the reinforcing fibers and the thermoplastic material on the moving support 2110. This process can form a core layer 2212 (see FIG. 22) with a high porosity that includes open cell structures formed from the reinforcing fibers that are held in place by the thermoplastic material. If desired, other materials may also be present in the core layer or sprayed onto the core layer 2212. For example, an adhesive from a reservoir can be sprayed on a surface of the formed core layer 2212 or a primer material to facilitate receipt of an ink onto a surface of the core layer 2212 may be sprayed on a surface of the formed core layer 2212. The exact temperature used to heat the web 2102 and/or core layer 2212 may vary and desirably the temperature is above a melting point of the thermoplastic material and below a melting point of the reinforcing materials. In some examples, the moving support itself 1910 can be heated, whereas in other examples the drying device 2110 can include a heating element or be configured as an oven or other heating devices. If desired, the drying device 2110 and the moving support 1910 can both provide heat to the web 2102 on the moving support 1910. In some instances, the moving support 1910 can include a thermally conductive material that can retain the heat from the drying device 2110 to assist in maintaining the core layer 2212 in a softened form during application of skin layers or other materials. In some examples, a pressure device 2320 separate from the drying device 2110 may be present (see FIG. 23). For example, a vacuum may be applied to the web 2102 to remove water from the web and leave behind the reinforcing materials and the thermoplastic material. The pressure device 2320 is typically upstream of the drying device 2110 and is designed to remove at least 40% by volume of the water from the web 2102, more particularly about 60% by volume of the water from the web 2102. If desired, another pressure device (not shown) can be downstream of the pressure device 2320.

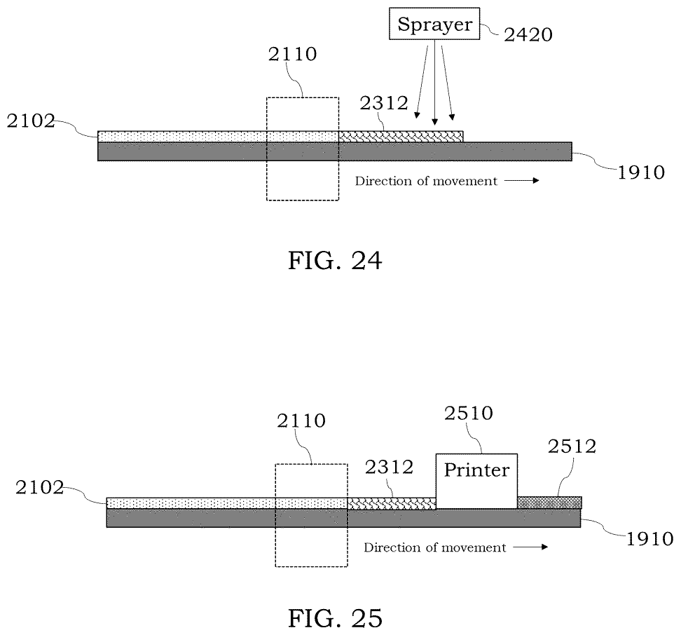

In certain embodiments, as the core layer 2312 exits the drying device 2110, one or more materials can be sprayed onto a surface of the core layer 2312 to provide a printable surface. Referring to FIG. 24, a sprayer 2420 that is fluidically coupled to a material tank (not shown) can be used to apply a primer or other material onto a surface of the core layer 2312 and provide a printable surface directly on the core layer 2312. The core layer with applied primer can then pass through a printer (FIG. 25) to print a design onto a surface of the core layer 2312 and provide a LWRT composite article 2512. As the LWRT composite articles are produced, they can be cut and stacked for shipping.

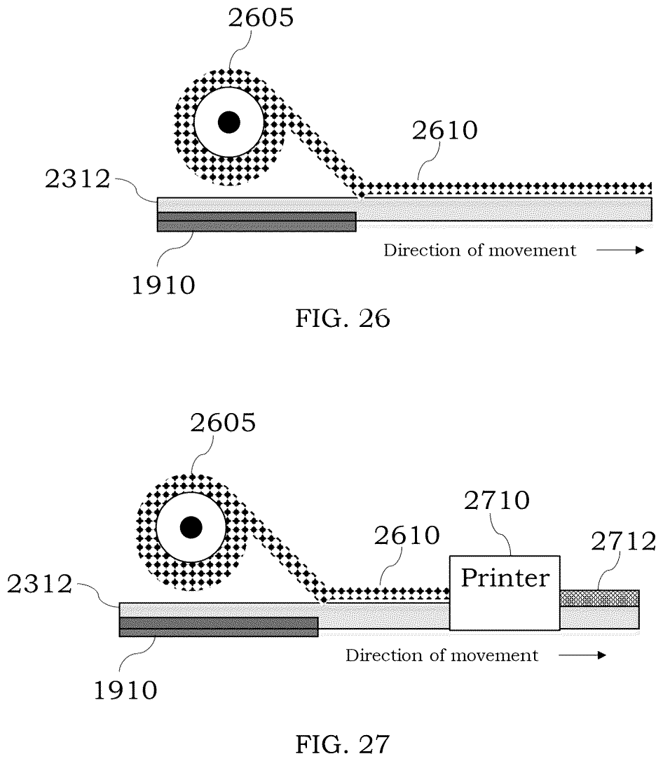

In another embodiments, a skin can be applied to a surface of a core layer in an automated process. The skin can include a pre-applied primer or may not include a primer. Referring to FIG. 26, one or more skin layers 2610 which can include a printable surface (or that have a surface that can be rendered to be a printable surface) can be applied to the core layer 2312. A skin layer 2610 with a printable surface is applied to a core layer 2312 as the core layer 2312 exits the moving support 1910 or remains moving along the moving support. For example, the skin layer 2610 may be present as a roll of skin layer material 2605 that is unrolled and applied in a continuous manner onto one surface of the core layer 2312. Where the skin layer 2610 includes a printable surface, the skin layer and core layer may then be used in combination with a printer 2710 (FIG. 27) to print a design onto a surface of the skin layer 2610 and provide a LWRT composite article 2712 with a printed design.

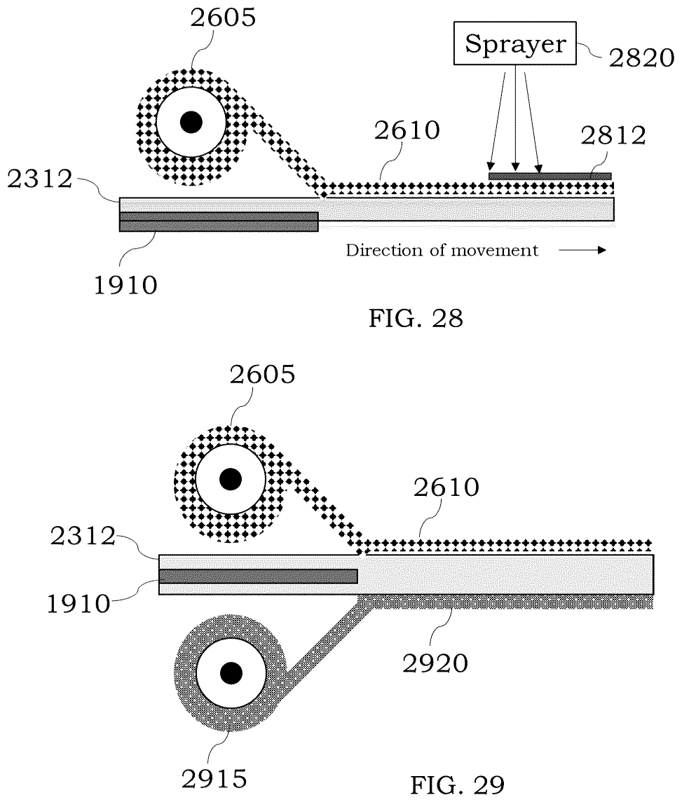

In instances where the applied skin does not have a printable surface, a sprayer (see FIG. 28) can spray a suitable material onto a surface of the applied skin 2610 to provide the printable surface 2812 on the skin 2610. The core and skin with printable surface can then be used with a printer (as shown in FIG. 27) to print a design onto the printable surface of the skin and provide a LWRT composite article including the printed design.

In certain embodiments and referring to FIG. 29, a second skin layer 2920 can be applied to a second surface of the core layer 2312 from a second roll 2915 including the second skin material. The skin layers 2610, 2920 can be applied at room temperature even though the core layer 2312 still may be heated otherwise be present on the moving support 1910 above room temperature. Alternatively, the rolls 2605, 2915 or skin layers 2610, 2920, or both, can be heated prior to being applied to the surfaces of the core layer 2312. The skin layers 2610, 2920 can generally be applied in a continuous manner to form a thermoplastic composite article that includes the core layer 2312, a first skin layer 2610 and optionally a second skin layer 2920. While not shown, additional skin layers can be applied on top of the skin layer 2610, 2920 using a similar process. In instances where the skin layer 2610 does not include a printable surface, a primer coating can be applied in a similar manner as shown in FIG. 28. A primer coating can also be applied to skin layer 2920 if desired or the skin layer 2920 may already include a printable surface prior to application to the core layer 2312. One or both of the skin layers 2610, 2920 can receive a printed design using a printer as shown in FIG. 27.

In some embodiments, it may be desirable to apply an adhesive layer on the core layer prior to applying the skin layer to the core layer. In such instances, an adhesive reservoir (not shown) can be present and used to spray adhesive on a surface of the core layer prior to application of the skin layer. Alternatively, the skin layer may include an adhesive or an adhesive or other material cam be sprayed onto the skin layer prior to application to the core layer. The exact adhesive used may vary from thermoplastic adhesives, thermosetting adhesives or combinations thereof. Illustrative adhesives include polyolefin adhesives, polyurethane adhesives and combinations thereof.

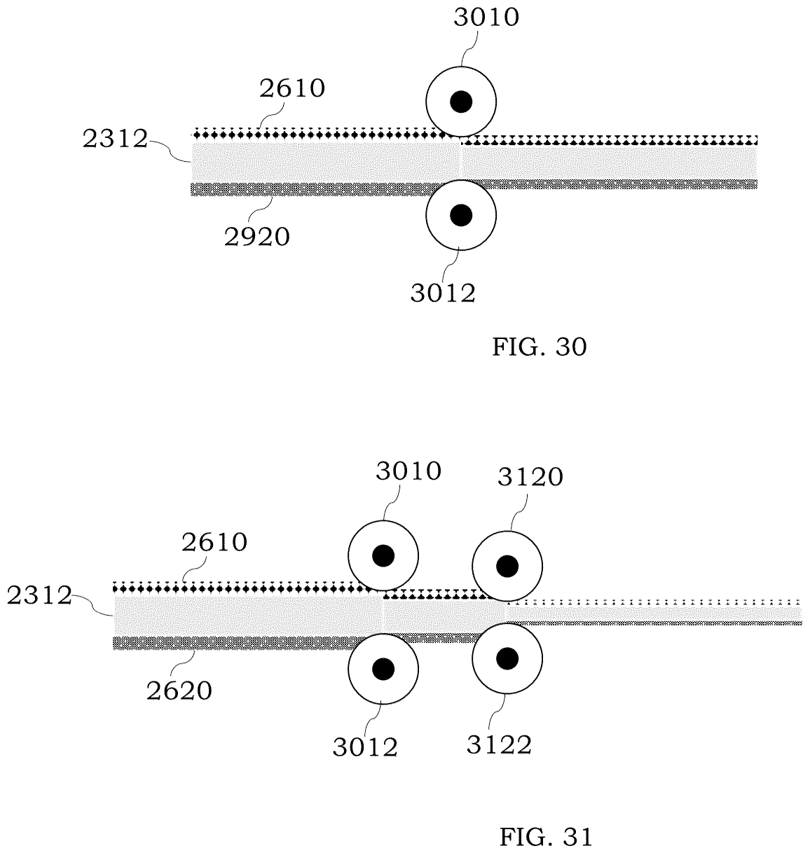

In certain embodiments, the resulting LWRT composite article can be consolidated by applying pressure to the surfaces of the LWRT composite article. For example and referring to FIG. 30, the composite article may pass between rollers 3010, 3012 to compress the composite article and enhance bonding of the skin layer(s) 2610, 2920 to the core layer 2312. Consolidation may be performed prior to printing a design onto the skin 2610 or after printing of the design onto the skin 2610. For example, the design can be printed onto the skin 2610, cured and then the LWRT composite article can be consolidated. Alternatively, the LWRT composite article can be consolidated and then the design can be printed onto the skin 2610 and cured. In some configurations, one or both of the rollers 3010, 3012 can include a design on the surface and consolidation can be performed simultaneously with printing of the design on the surface. For example, gravure printing or other non-digital printing can be used in combination with a roller including a design to print the design onto the surface. The exact distance or gap between the rollers 3010, 3012 may vary depending on the desired pressure to be applied and depending on a desired final thickness for the composite article. In general, an overall thickness of the composite article decreases after passing through the rollers 3010, 3012. The rollers 3010, 3012 can be operated at room temperature, above room temperature or below room temperature. If desired, more than a single set of rollers 3010, 3012 can be present. For example and referring to FIG. 31, a second set of rollers 3120, 3122 are shown. The gap between the different sets of rollers may be different. For example, a first set of rollers 3010, 3012 may include a first gap that is less than a gap between the rollers 3120, 3122. The gap between the various rollers may be fixed or may vary. For example, it may be desirable to compress certain areas of the composite article to a greater degree so the thickness at these compressed areas is lower. In some instances, edges of the composite article can be compressed more so a thickness at the side edges of the composite article is lower. Three, four or more sets of rollers may be present if desired. The rollers can be positioned within an oven or heating device, if desired, to maintain the core layer in a softened form during consolidation of the composite article.

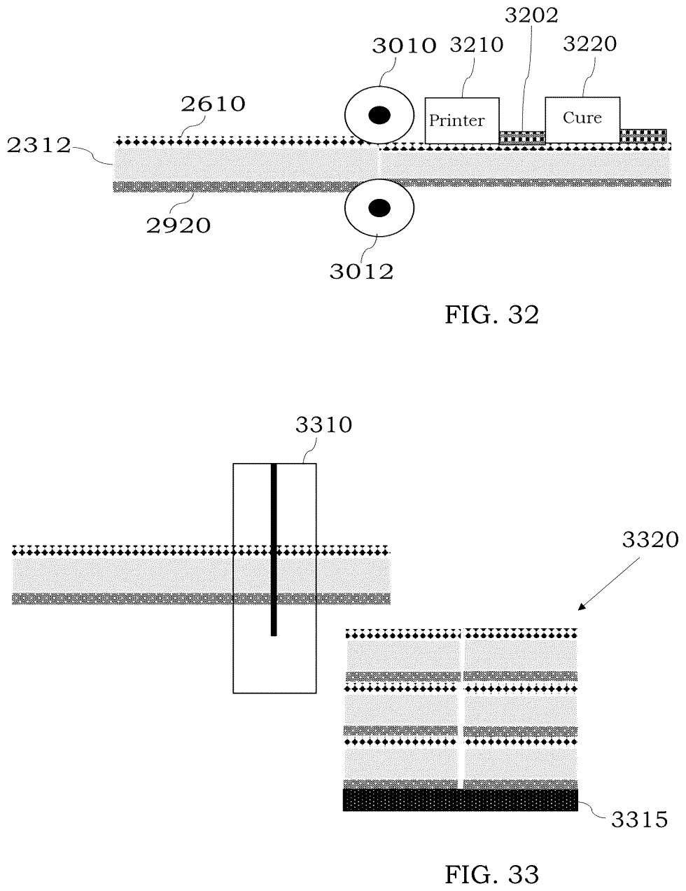

In certain configurations, the ink or colorant added to the surface of the LWRT composite article is typically cured using light, infrared light, UV light, heat, or other means. Alternatively, any solvents in the ink can be removed using heat or other means and leave the ink behind on the surface. FIG. 32 shows on illustration where a printer 3210 prints ink onto the skin 2610 of a composite article. The printed surface subsequently passes through a curing station 3220 to cure the ink on the skin 2610. If desired, the printer 3210 could include an integral curing station or component and the curing station 3220 could be omitted. The resulting LWRT composite article includes the core layer 2312, the skin layer 2610 with printed design 3202 on one surface of the core layer 2312 and the skin layer 2920 on an opposite surface of the core layer 2312.

In certain embodiments, once the composite article is consolidated, the continuous sheet of consolidated composite article can be cut or guillotined into individual sheets using a cutting device 3310 (see FIG. 33). The resulting individual composite articles can be stacked or palletized, e.g., on pallet 3315, for shipping as shown in the stack 3320. The dimensions of the composite article in FIG. 33 have been intentionally enlarged to show the stacking, since the composite articles tend to be stacked as individual thin sheets with a thickness, for example, from 1 mm to about 30 mm. The exact size of the individual composite articles may vary from about 2 feet wide to about 8 feet wide and about 4 feet long to about 16 feet long. In some embodiments, the individual composite article may be about 4 feet wide and about 8 feet long so it has similar dimensions to plywood panels commonly used in recreational vehicles.

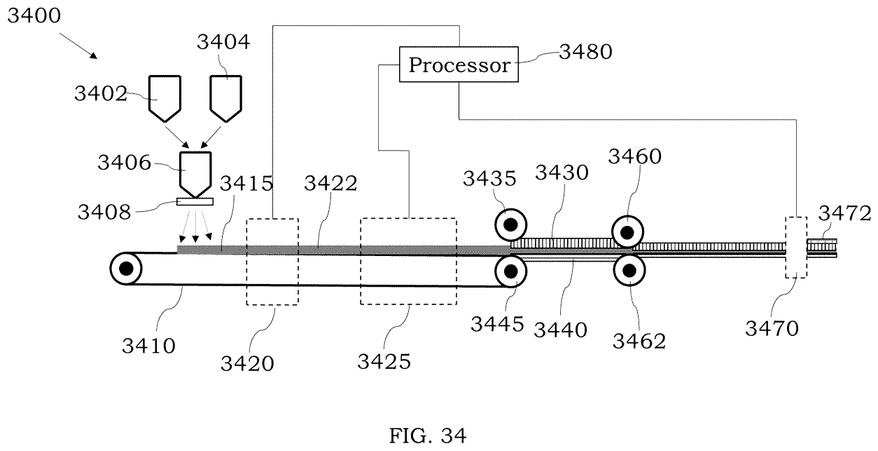

In certain configurations, a system can be used to implement an in-line process to print designs onto a surface of a LWRT composite article. An illustration of components of the system are shown in FIG. 34. The system 3400 includes reservoirs 3402, 3404. Reservoir 3402 can receive a thermoplastic material, and reservoir 3404 can receive reinforcing materials such as fibers. The reservoirs 3402, 3404 can provide materials to a mixing tank 3406. The mixing tank 3406 can be fluidically coupled to a spray head or nozzles 3408 to spray the mixed dispersion onto a moving support 3410. The web 3415 on the moving support 3410 can travel through a vacuum or other pressure device 3420, which can remove the liquid from the web 3415 to form a core layer 3422. The core layer 3422 can pass through a drying device 3425 to dry and heat the core layer. Skin layers 3430, 3440 can be applied from supply devices or rolls 3435, 3445 respectively onto opposite surface of the core layer 3422 to provide a composite article. In some instances, at least one of the skin layers 3430, 3440 can include a printable surface or a primer material can be sprayed onto the surface of one or both of the skin layer 3430, 3440 to render the surface printable. The composite article can pass through a set of rollers 3460, 3462 to consolidate the composite article. A design 3472 can then be printed onto the printable surface of the skin layer 3430 using a printer 3470. A processor 3480 is shown that can control, for example, movement of the moving support 3410, spraying of the material onto the moving support 3410, the design provided to the printer 3470 and other devices and parameters used by the system 3400.

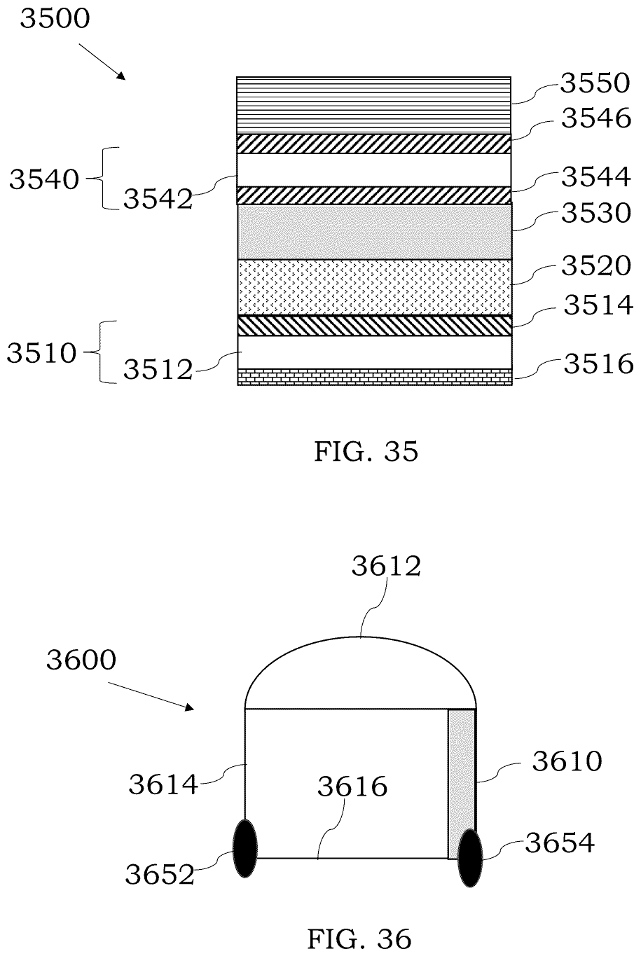

In certain embodiments, the in-line processes and in-line system described herein can be used to produce a side wall, interior wall panel, interior ceiling panel or other interior components. For example, the wall panel or ceiling panel can be present in a recreational vehicle or other vehicles, a cubicle, an office wall, a residential wall or in other settings. One illustration is shown in FIG. 35 where an RV wall 3500 includes a first laminated lightweight reinforced thermoplastic composite article 3510 comprising a porous core layer 3512, a first skin layer 3514 on a first surface of the porous core layer 3512 and a second skin layer 3516 comprising a printed design on a second surface of the porous core layer. The printed design of the skin layer 3516 is typically positioned so it faces an interior portion of the space formed by the RV wall 3500. The RV wall 3500 can also include a foam layer 3520 coupled to the first laminated lightweight reinforced thermoplastic composite article 3510 at a first surface of the foam layer. For example, the foam layer 3520 can be coupled to the first laminated lightweight reinforced thermoplastic composite article 3510 through the first skin layer 3514 of the first laminated lightweight reinforced thermoplastic composite article 3510 so the patterned second skin layer 3516 is present on an interior surface of the RV wall 3500. The RV wall 3500 also typically includes a support structure 3530, which can take the form of a chassis, tubing, a cage or other structures. The support structure 3530 typically includes a metal such as steel, aluminum or the metals. The support structure 3530 can be coupled a second surface of the foam layer 3520 at a first surface of the support structure 3530. An exterior panel is typically coupled to the support structure 3530 either directly or through other layers or panels. In one configuration, a second laminated lightweight reinforced thermoplastic composite article 3540 can be coupled to a second surface of the support structure 3530. The second laminated lightweight reinforced thermoplastic composite article 3540 comprises a porous core layer 3542, a first skin layer 3544 on a first surface of the porous core layer 3542 and a second skin layer 3546 on a second surface of the porous core layer 3542. An exterior panel 3550 can be coupled to the second laminated lightweight reinforced thermoplastic composite article 3540 to form the RV wall 3500. In some examples, the exterior panel 3550 comprises fiberglass or aluminum. The skin layer 3516 can include a printed design that is one or more of a woodgrain design, a marble design, a tile design, a random design, a pinwheel design, a herringbone design, a brick design, an offset staggered brick design, an offset design, a grid design, a stacked vertical design, a French design, a basket weave design, a diamond design, a chevron design or other designs. In some embodiments, the design on the surface of the skin layer 3516 is produced using a digital image and is substantially the same as the digital image. In certain embodiments, the first skin layer 3514 of the first laminated lightweight reinforced thermoplastic composite article 3510 comprises a scrim. In certain examples, the porous core layer 3512 in the first laminated lightweight reinforced thermoplastic composite article 3510 can include a web comprising open cell structures formed from reinforcing fibers held together by a thermoplastic material as noted above. In some examples, the porous core layer 3542 in the second laminated lightweight reinforced thermoplastic composite article comprises a web comprising open cell structures formed from reinforcing fibers held together by a thermoplastic material. In some configurations, the thermoplastic material in each porous core layer 3510, 3540 independently comprises a thermoplastic material as noted herein, e.g., a polyolefin such as, for example, polypropylene, polyethylene, etc. In some embodiments, the reinforcing materials in each porous core layer comprise reinforcing fibers as noted herein, e.g., glass fibers.

In certain embodiments, the RV wall may be present in a recreational vehicle comprising a roof, side walls coupled to the roof, and a floor coupled to the sidewalls to provide an interior space within the recreational vehicle, One illustration is shown in FIG. 36, where an RV 3600 comprises an RV wall 3610, which can be similar to the RV wall 3500 described above. The RV 3600 also includes a roof 3612, another side wall 3614 and a floor 3616. The RV 3600 may include wheels 3652, 3654 to permit towing of the RV and/or may include an engine, electric motor or other power source to permit independent movement of the RV. If desired, similar panels may be used in RV ceilings. The panels on the walls and the ceiling can be the same or can be different.

In certain examples, the in-line methods and in-line systems described herein may be controlled using one or more processors, which can be part of the in-line system or otherwise electrically coupled to the in-line system through an associated device, e.g., computer, laptop, mobile device, etc. For example, the processor can be used to control the mixing speed of the materials, the speed of the moving support, the pressure used to remove liquid from the disposed dispersion, the temperature of the heating device(s), the pressure applied to the materials, the images provided to the printer and other parameters of the process and system. Such processes may be performed automatically by the processor without the need for user intervention or a user may enter parameters through a user interface. In certain configurations, the processor may be present in one or more computer systems and/or common hardware circuitry including, for example, a microprocessor and/or suitable software for operating the system, e.g., to control the various fluid reservoirs, mixing tank, pressure devices, speed, temperatures, printer, sprayers, etc. The processor can be integral to the in-line system or may be present on one or more accessory boards, printed circuit boards or computers electrically coupled to the components of the in-line system. The processor is typically electrically coupled to one or more memory units to receive data from the other components of the system and permit adjustment of the various system parameters as needed or desired. The processor may be part of a general-purpose computer such as those based on Unix, Intel PENTIUM-type processor, Intel Core™ processors, Intel Xeon™ processors, AMD Ryzen™ processors, AMD Athlon™ processors, AMD FX™ processors, Motorola PowerPC, Sun UltraSPARC, Hewlett-Packard PA-RISC processors, Apple-designed processors including Apple A14 Bionic processor, A13 Bionic processor, A12 processor, Apple A11 processor and others or any other type of processor. One or more of any type computer system may be used according to various embodiments of the technology. Further, the system may be connected to a single computer or may be distributed among a plurality of computers attached by a communications network. If desired, different components of the in-line system may be controlled by a respective processor or computer that is separate from a processor or computer used to control other components of the in-line system. It should be appreciated that other functions, including network communication, can be performed and the technology is not limited to having any particular function or set of functions. Various aspects may be implemented as specialized software executing in a general-purpose computer system. The computer system may include a processor connected to one or more memory devices, such as a disk drive, memory, or other device for storing data. Memory is typically used for storing programs, temperatures, moving support speeds and other values used in the in-line process. Components of the computer system may be coupled by an interconnection device, which may include one or more buses (e.g., between components that are integrated within a same machine) and/or a network (e.g., between components that reside on separate discrete machines). The interconnection device provides for communications (e.g., signals, data, instructions) to be exchanged between components of the system. The computer system typically can receive and/or issue commands within a processing time, e.g., a few milliseconds, a few microseconds or less, to permit rapid control of the system. The processor typically is electrically coupled to a power source which can, for example, be a direct current source, an alternating current source, a battery, a solar cell, a fuel cell or other power sources or combinations of power sources. The power source can be shared by the other components of the system. The system may also include one or more input devices, for example, a keyboard, mouse, trackball, microphone, touch screen, manual switch (e.g., override switch) and one or more output devices, for example, a printing device, display screen, speaker. In addition, the system may contain one or more communication interfaces that connect the computer system to a communication network (in addition or as an alternative to the interconnection device). The system may also include suitable circuitry to convert signals received from the various electrical devices present in the systems. Such circuitry can be present on a printed circuit board or may be present on a separate board or device that is electrically coupled to the printed circuit board through a suitable interface, e.g., a serial ATA interface, ISA interface, PCI interface, a USB interface, a Fibre Channel interface, a Firewire interface, a M.2 connector interface, a PCIE interface, a mSATA interface or the like or through one or more wireless interfaces, e.g., Bluetooth, Wi-Fi, Near Field Communication or other wireless protocols and/or interfaces.

In certain embodiments, the storage system used in the systems described herein typically includes a computer readable and writeable nonvolatile recording medium in which codes of software can be stored that can be used by a program to be executed by the processor or information stored on or in the medium to be processed by the program. The medium may, for example, be a hard disk, solid state drive or flash memory. The program or instructions to be executed by the processor may be located locally or remotely and can be retrieved by the processor by way of an interconnection mechanism, a communication network or other means as desired. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in the storage system or in the memory system. The processor generally manipulates the data within the integrated circuit memory and then copies the data to the medium after processing is completed. A variety of mechanisms are known for managing data movement between the medium and the integrated circuit memory element and the technology is not limited thereto. The technology is also not limited to a particular memory system or storage system. In certain embodiments, the system may also include specially-programmed, special-purpose hardware, for example, an application-specific integrated circuit (ASIC), microprocessor units MPU) or a field programmable gate array (FPGA) or combinations thereof. Aspects of the technology may be implemented in software, hardware or firmware, or any combination thereof. Further, such methods, acts, systems, system elements and components thereof may be implemented as part of the systems described above or as an independent component. Although specific systems are described by way of example as one type of system upon which various aspects of the technology may be practiced, it should be appreciated that aspects are not limited to being implemented on the described system. Various aspects may be practiced on one or more systems having a different architecture or components. The system may comprise a general-purpose computer system that is programmable using a high-level computer programming language. The systems may also be implemented using specially programmed, special purpose hardware. In the systems, the processor is typically a commercially available processor such as the well-known microprocessors available from Intel, AMD, Apple and others. Many other processors are also commercially available. Such a processor usually executes an operating system which may be, for example, the Windows 7, Windows 8 or Windows 10 operating systems available from the Microsoft Corporation, MAC OS X, e.g., Snow Leopard, Lion, Mountain Lion, Mojave, High Sierra, El Capitan or other versions available from Apple, the Solaris operating system available from Sun Microsystems, or UNIX or Linux operating systems available from various sources. Many other operating systems may be used, and in certain embodiments a simple set of commands or instructions may function as the operating system.

In certain examples, the processor and operating system may together define a platform for which application programs in high-level programming languages may be written. It should be understood that the technology is not limited to a particular system platform, processor, operating system, or network. Also, it should be apparent to those skilled in the art, given the benefit of this disclosure, that the present technology is not limited to a specific programming language or computer system. Further, it should be appreciated that other appropriate programming languages and other appropriate systems could also be used. In certain examples, the hardware or software can be configured to implement cognitive architecture, neural networks or other suitable implementations. If desired, one or more portions of the computer system may be distributed across one or more computer systems coupled to a communications network. These computer systems also may be general-purpose computer systems. For example, various aspects may be distributed among one or more computer systems configured to provide a service (e.g., servers) to one or more client computers, or to perform an overall task as part of a distributed system. For example, various aspects may be performed on a client-server or multi-tier system that includes components distributed among one or more server systems that perform various functions according to various embodiments. These components may be executable, intermediate (e.g., IL) or interpreted (e.g., Java) code which communicate over a communication network (e.g., the Internet) using a communication protocol (e.g., TCP/IP). It should also be appreciated that the technology is not limited to executing on any particular system or group of systems. Also, it should be appreciated that the technology is not limited to any particular distributed architecture, network, or communication protocol.

In some instances, various embodiments may be programmed using an object-oriented programming language, such as, for example, SQL, SmallTalk, Basic, Java, Javascript, PHP, C++, Ada, Python, iOS/Swift, Ruby on Rails or C#(C-Sharp). Other object-oriented programming languages may also be used. Alternatively, functional, scripting, and/or logical programming languages may be used. Various configurations may be implemented in a non-programmed environment (e.g., documents created in HTML, XML or other format that, when viewed in a window of a browser program, render aspects of a graphical-user interface (GUI) or perform other functions). Certain configurations may be implemented as programmed or non-programmed elements, or any combination thereof. In some instances, the systems may comprise a remote interface such as those present on a mobile device, tablet, laptop computer or other portable devices which can communicate through a wired or wireless interface and permit operation of the in-line system remotely as desired.

In certain examples, the processor may also comprise or have access to a database of images that can be used to produce specific articles. For example, specific digital images can be used to print designs onto a core layer or skin layer. The instructions stored in the memory can execute a software module or control routine for the system, which in effect can provide a controllable model of the in-line system. The processor can use information accessed from the database together with one or software modules executed in the processor to determine control parameters or values for different components of the systems, e.g., different temperatures, different pressures, different consolidation devices, different images, printing speeds, curing, etc. Using input interfaces to receive control instructions and output interfaces linked to different system components in the system, the processor can perform active control over the system.

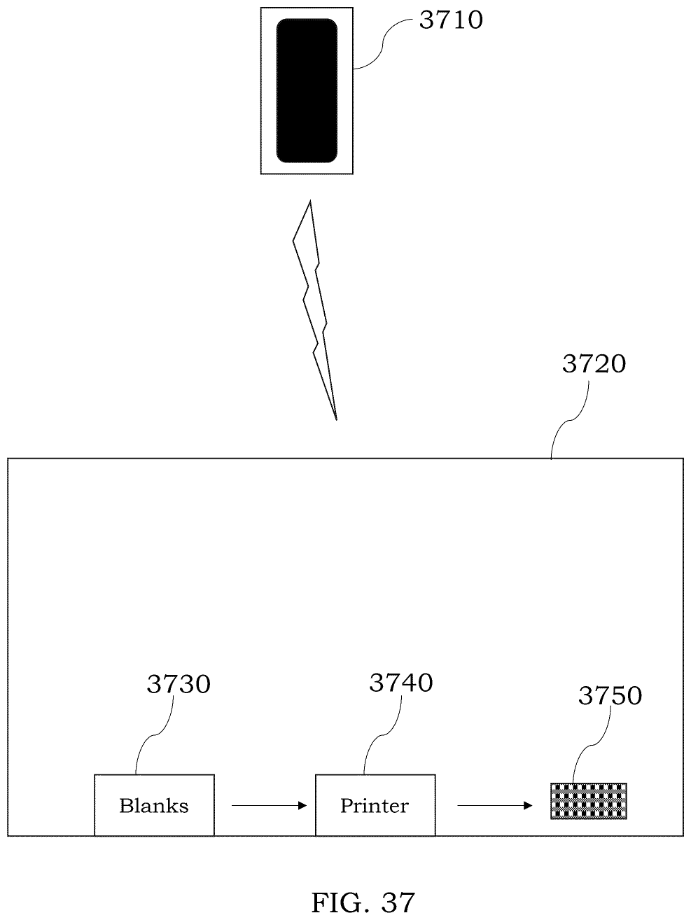

In certain embodiments, the LWRT composite articles described herein can be provided as “blanks” and include a printable surface without any design on them. Manufacturers or consumers can use the blanks in combination with their own printer to print a design onto the blanks. This results permits customization of designs and small runs of panels including a certain design. In some configurations, a user interface can be present on a mobile device or computer to permit an end user to order a specific number of panels through the user interface. The store or seller can then produce the ordered number of panels, with the specific design selected by the end user, at the point of sale to provide panels with customized designs. An illustration is shown in FIG. 37 where a mobile device 3710 is used to transmit a remote order to a production site 3720. Where digital printing is used, the user can upload a selected or customized design through the mobile device for printing on the panels. Blanks 3730 are used along with an on-site printer 3740 to produce the customized panel 3750. The user may then pick up the panel 3750 once produced.

Certain specific examples of LWRT composite articles that can be produced with printed designs using an in-line process and tested are discussed below.

### Example 1

Two LWRT composite articles were produced with core basis weights of 960 gsm and included polypropylene and reinforcing glass fibers. On one side of the core layer was a film including biaxially oriented polyester resin or chips. The film included a water-based primer on an opposite side and a low melt hot-melt layer on the inner side toward the core layer. On the other side of the core layer was a scrim layer (23 gsm). The samples were labeled ST-14927B and ST-15240 for testing purposes.

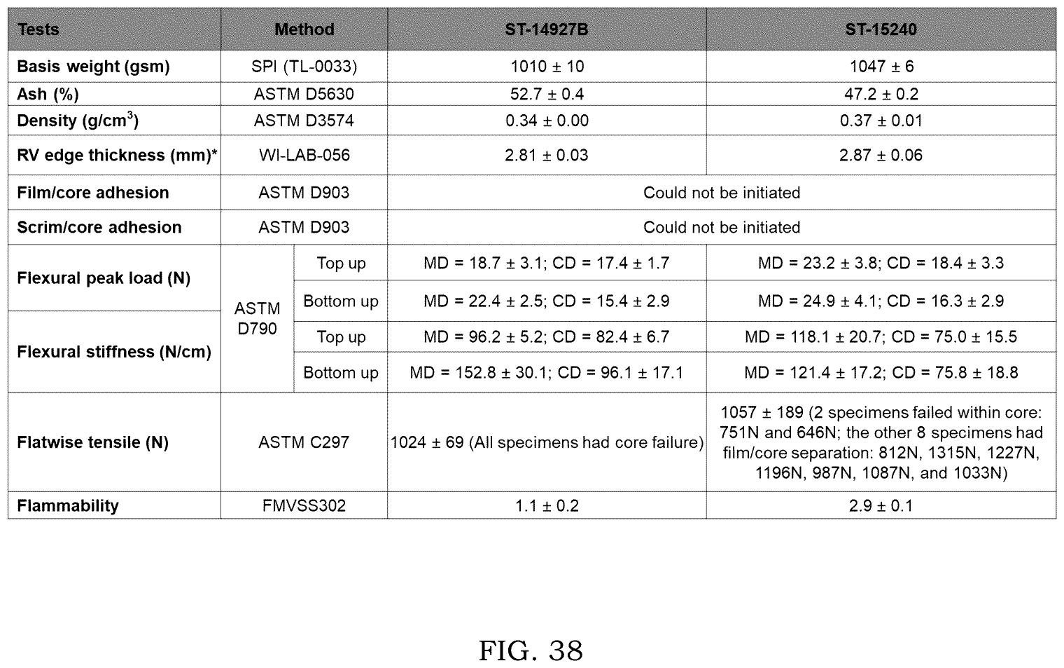

Several physical tests were performed on the samples and the results are shown in FIG. 38. The panels both met the flammability tests for use as interior panels and had suitable mechanical properties. Delamination between the film and the core was not observed in either sample.

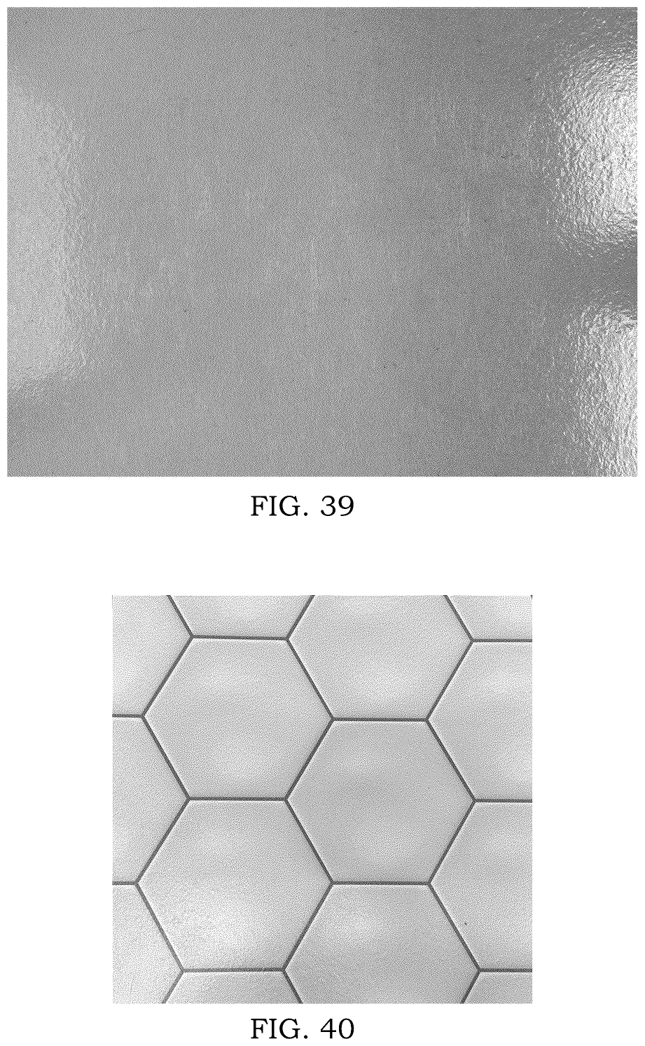

An image of the top surface of the LWRT composite article is shown in FIG. 39 and shows some inherent texture on the board due to the underlying glass fibers.

A digital inkjet printer was used to print a hexagonal design onto the board of FIG. 39. The digital printer used UV curable ink. The resulting printed design is shown in FIG. 40.

### Example 2

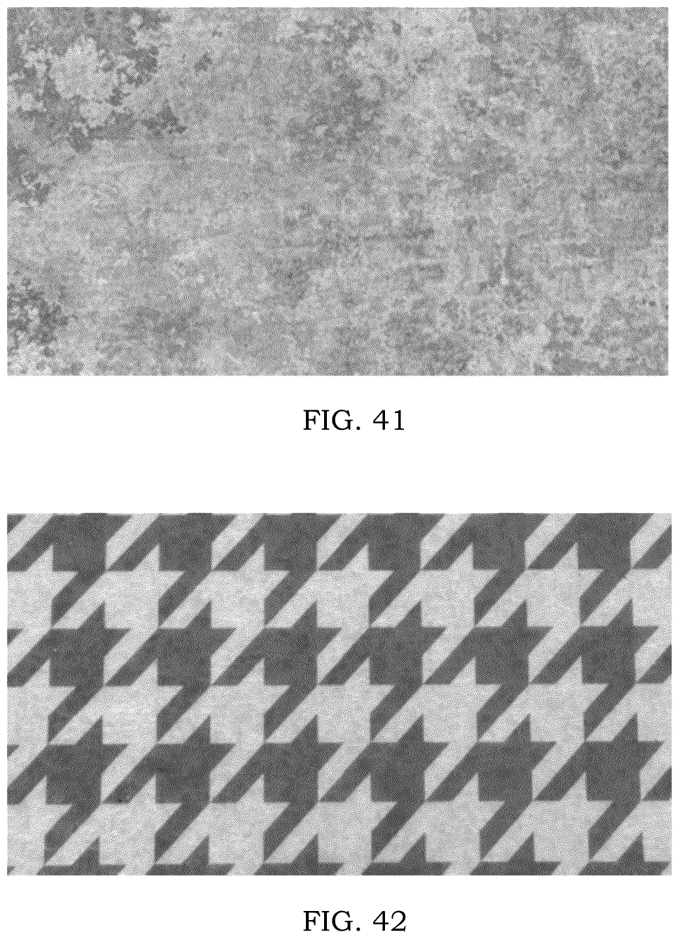

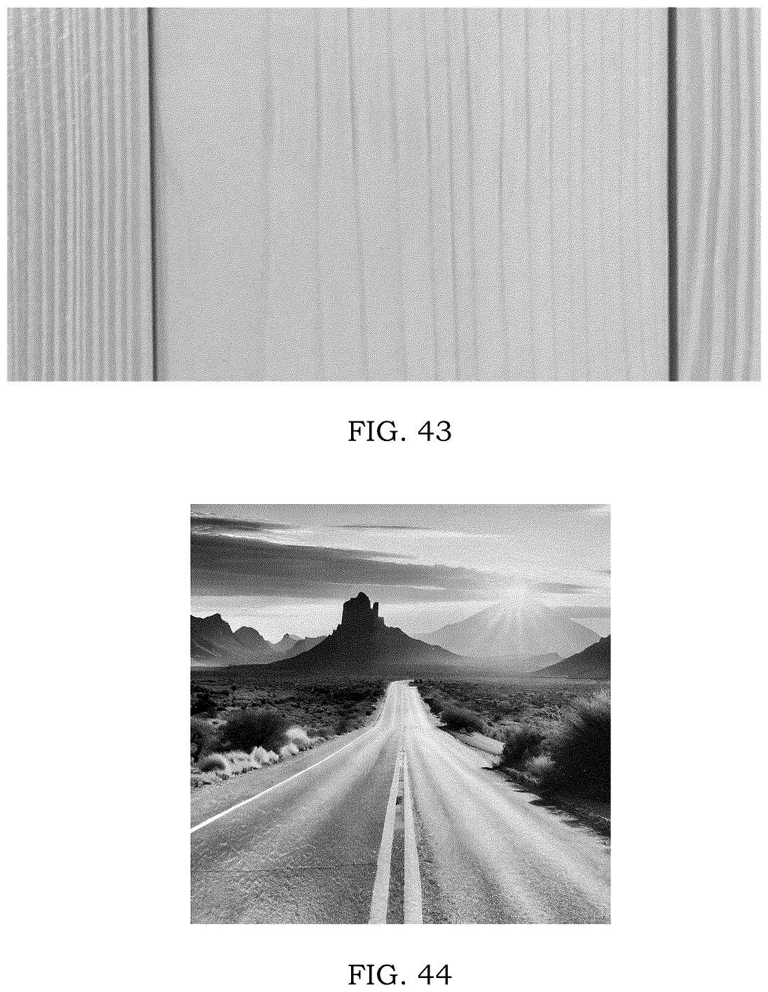

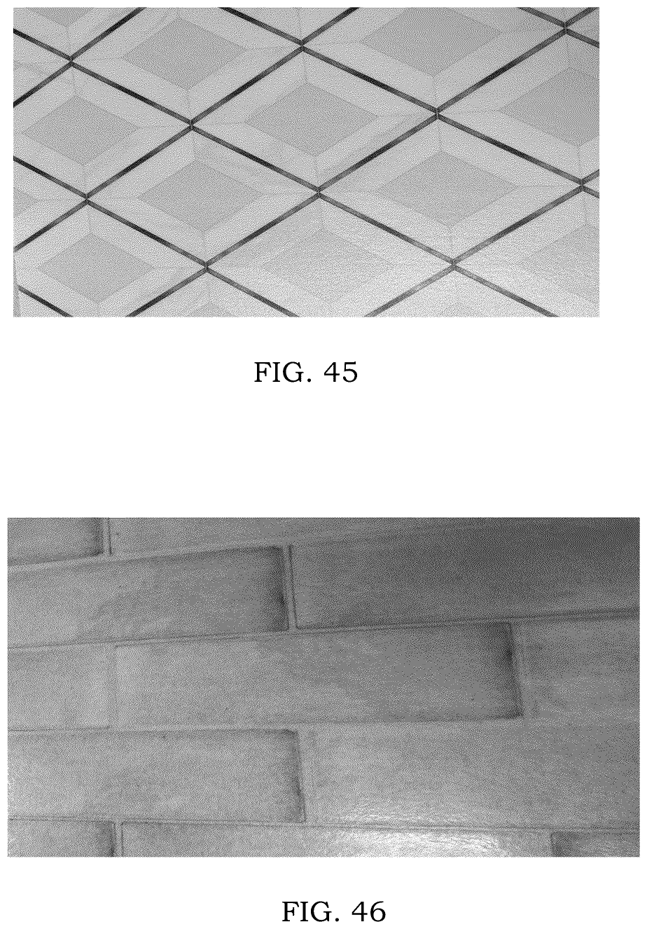

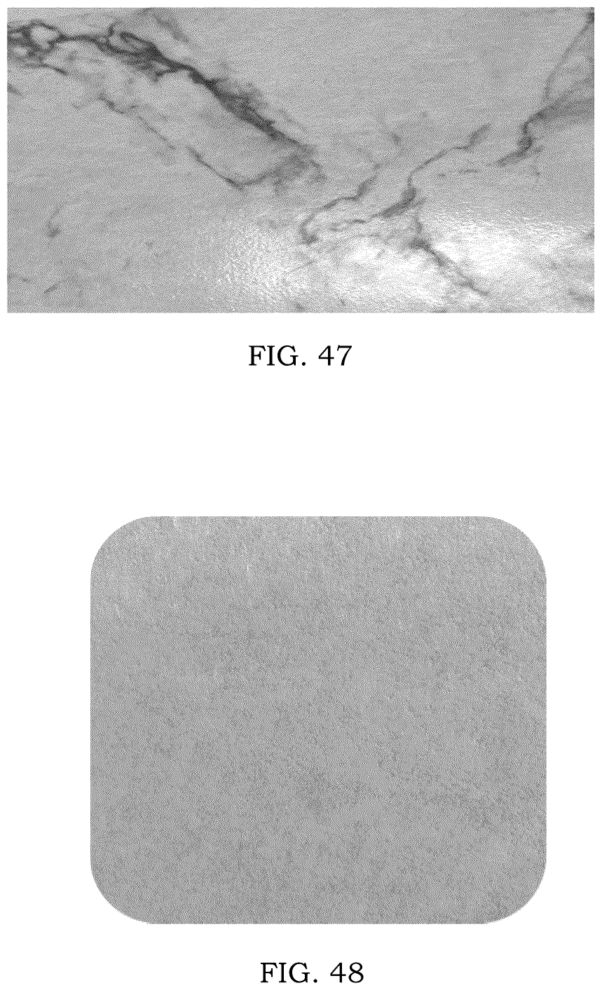

The core layer with deposited film (FIG. 39) was used to print numerous additional images onto the film surface using an inkjet printer including a printed hexagonal design (FIG. 40), a stone design (FIG. 41), a repeating geometric design (FIG. 42), a woodgrain design (FIG. 43), a desert scene (FIG. 44), a diamond design (FIG. 45), a brick design (FIG. 46) and a marble design (FIG. 47). Each image was printed using a digital inkjet printer and UV curable ink. The printed design remained intact after curing with UV light.

### Example 3

Two LWRT composite articles were prepared with skins on each surface of a porous core layer including 45% by weight polypropylene and 55% by weight glass fibers. The top skin on each LWRT composite article was a 23 gsm black nonwoven scrim. The bottom skin on one article (LWRT_pr1) was a 23 gsm printable PET film. The bottom skin on the other article (LWRT_pr2) was a 94 gsm printable PET film. Various physical properties for each LWRT composite article are shown in Table 2 below. The physical and analytical tests were conducted on disks with 99 mm diameter according to an internal standard procedure. The areal density (gsm, 5 replicates), ash content (%, 5 replicates), density (g/cm³, 5 replicates), and as-produced thickness (mm, 5 replicates) were measured.

TABLE 2

| | Areal Density | Ash Content | Thickness | Density |
|---|---|---|---|---|
| Sample | (gsm) | (%) | (mm) | (g/cm³) |
| LWRT_pr1 | 1047 ± 6 | 47.2 ± 0.2 | 2.87 ± 0.06 | 0.36 ± 0.00 |
| LWRT_pr2 | 1061 ± 6 | 48.6 ± 0.3 | 2.92 ± 0.04 | 0.36 ± 0.02 |

The LWRT_pr2 sample was used to print a design on its surface with a 3D printing process using UV-curable ink. FIG. 48 is an image of the LWRT composite (viewing the bottom skin) before printing, and FIG. 49 is an image of two LWRT composites, positioned side-by-side, after printing (also viewing the bottom skin).

The ink adhesion to the printable film surface of LWRT composite article was assessed using ASTM D3359-22, Method B. Cross-cut lattice pattern is created with six cuts in each direction on the printed surface. After making the incisions are made, a pressure-sensitive adhesive tape (Permacel 99 tape) is gently applied over the cut with a rubber roller. Following a brief “recovery” period of about 60 seconds, the tape is removed by grasping the free end of the tape and pulling it off rapidly (not jerked) back upon itself at as close to an angle of 180° as possible. The amount of ink removed from the printed surface is rated on a scale of GB to 5B, where 0 indicates no adhesion and 5 indicates complete adhesion.

The surface energy of the film on the two printable boards ranged from 38 to 40 dynes/cm, ensuring compatibility with the UV curable ink. An example of the LWRT_pr2 sample, which was printed with a custom design using a 3D digital printing process, and the 3D design was achieved with multiple layers of printed ink laid on top of each other adhesion test for both the LWRT_pr1 and LWRT_pr2 samples, no peeling or removal of the ink was observed, suggesting the ink adhesion was rated as 5B with the edges of the cuts are completely smooth and none of the squares of the lattice detached.

These results were consistent with being able to digitally print a design into a surface of the LWRT composite article and retention of the ink on the surface post-printing.

### Example 4

Flame spread index tests were conducted on the LWRT_pr1 and LWRT_pr2 articles according to ASTM E84-23. The specimen used in the test measured a nominal 24 feet (7.32 m) in length and 20 inches (508 mm) in width, subjected to controlled airflow and flaming exposure calibrated to produce a specific flame spread distance over time, using select grade red oak flooring. Based on flame progression, a dimensionless FSI is calculated from the area under the flame spread distance-time curve. For the calculation of the SDI, the areas for reinforced cement board (SDI=0) and red oak flooring (SDI=100) were used. The results are listed below in Table 3.

TABLE 3

| | Flame Spread | Smoke Development | ASTM E84 Class |
|---|---|---|---|
| Samples | Index (FSI) | Index (SDI) | Rating |
| LWRT_pr1 | 20 | 145 | Class A |
| LWRT_pr2 | 35 | 195 | Class B |

### Example 5

The FMVSS 302 burning rate was measured on the LWRT composites of Example 3 with the film side (bottom skin) facing the Bunsen burner flame. The results are shown in Table 4 below.

TABLE 4

| Samples | Burning Rate (inches/min) |
|---|---|
| LWRT_pr1 | 2.9 ± 0.1 |
| LWRT_pr2 | 2.3 ± 0.0 |

Based on the obtained burning rates, both LWRT composite articles with printable surfaces passed the FMVSS 302 test.

### Example 6

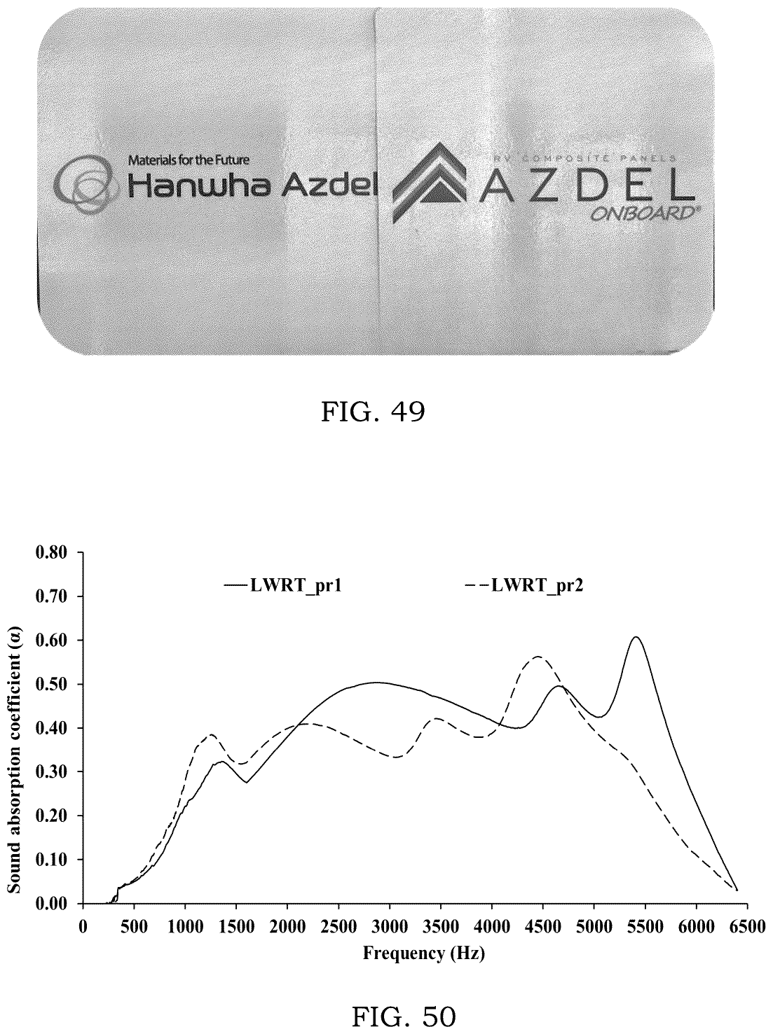

Sound absorption measurements of the two LWRT composite articles with printable surfaces of Example 3 were measured according to ASTM E1050. The sound frequency range at which the assessments were performed was 250 Hz to 6.5 kHz. The non-woven scrim side faced sound source for all the three materials. Both larger tube (99 mm diameter) and small tube (29 mm) were used. The large tube is set up to measure parameters in the frequency range from 250 Hz to 1.6 kHz, while the small tube is set up to measure parameters in the frequency range from 500 Hz to 6.4 kHz. For each material, the test was repeated three times using the large tube with the sample removed. Once complete, the testing process was repeated three times using the small tube. The sound absorption coefficient (a) was determined for the composites using a two-microphone transfer-function method below.

$$α = 1 - \frac{{I}_{R}}{{I}_{I}}$$

where α, I_{R}, and I_{I} are the sound absorption coefficient, one-sided intensity of the reflected sound and the one-sided intensity of the incident sound, respectively. An a value close to 1 indicates a good absorption, while an alpha close to zero suggests the material has a good reflection of sound energy. The results are shown in the graph in FIG. 50.

In the lower frequency range, i.e. <2200 Hz, the LWRT_pr2 material had the highest sound absorption. When frequency was between 2200 Hz and 3200 Hz, LWRT_pr1 had better sound absorption performance. LWRT_pr1 and LWRT_pr2 were both good in the range of 3200 Hz and 4100 Hz. When the frequency was higher than 5000 Hz, the LWRT_pr1 had a significantly higher a value. The long glass fibers in these LWRT composites enhance the structural integrity and sound-damping properties of the LWRT core.

### Example 7

Peak load and stiffness values of the LWRT composite articles of Example 3 were measured. Flexural (3-point bending) testing was performed on the samples (LWRT_pr1, LWRT_pr2) according to ASTM D790-07. Ten rectangular (25 mm×100 mm) specimens were cut out in the machine direction (MD) and cross-machine direction (CD). The test was performed on an MTS mechanical testing machine using a 250 N load cell. The crosshead speed, span, anvil diameter, and nose diameter were set for 15 mm/min, 64 mm, 6.4 mm, and 6.4 mm, respectively.

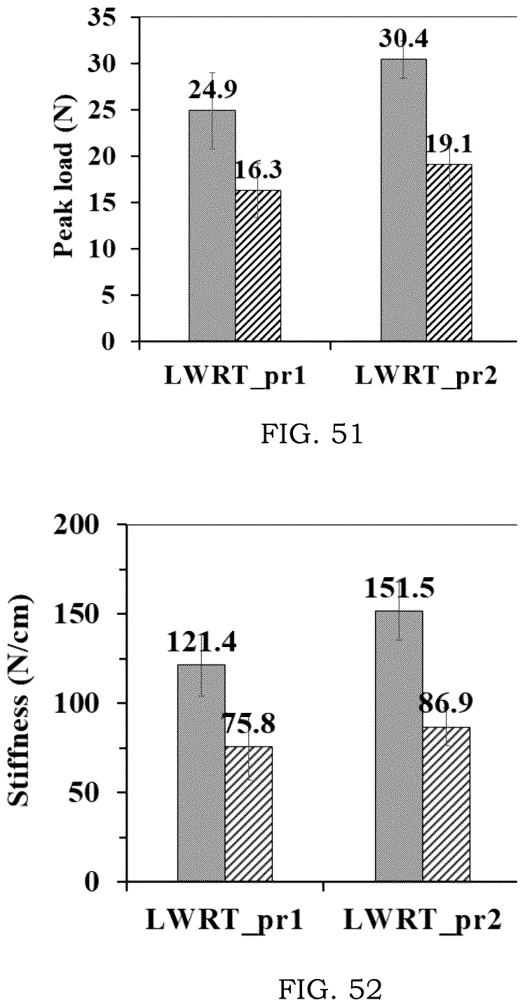

The measured values are shown in the graphs of FIGS. 51 and 52. The left bar in each grouping represents the machine direction values, and the right bar represents the cross-direction values.

LWRT_pr2 materials had a 22% higher strength in MD and 17% higher in CD than the LWRT_pr1. Similarly for the stiffness, the LWRT_pr2 panel has about 25% higher in MD and 15% higher in CD as compared to the LWRT_pr1 attributed to the layer of the thicker printable film used in LWRT_pr2. These LWRT panels offer higher strength-to-weight and stiffness-to-weight ratios ascribed to their exceptionally low weight. The flexural properties of these light-weight composite flat sheets can be tuned by changing the core formulations, areal density and even the skin materials.

### Example 8

Flatwise tensile measurements were performed on the two LWRT composite articles of Example 3. The flatwise tensile (FWT) test of the samples (LWRT_pr1, LWRT_pr2) was performed on an MTS mechanical testing machine according to ASTM C297-04. Ten specimens (51 mm×51 mm) were cut out across the cross-machine direction of a production scale flat sheet. Cross head speed was 50 mm/min and the load cell was 5 kN. Specimens were bonded onto tensile fixtures/end tabs (top and bottom) with urethane glue/adhesive (3M Scotch-Weld 3535; ratio of weight for Base to Accelerator is 100:105; density is about 1.29 g/cm3), and the glued samples were left in air for 24 hours to allow the glue to fully cure before conducting the test.

Measured peak load values were 1057±189 N for LWRT_pr1 and 1089±181 N for LWRT_pr2. Failure occurred within the LWRT composite core for the two tested panels. These results indirectly suggest the bonding adhesion between the printable film and porous core layer was stronger than the z-direction strength values in the FWT test.

### Example 9

Peel 180° test was performed on the films for the two printable samples (LWRT_pr1 and LWRT_pr2) using a MTS testing machine with a 250 N load cell following ASTM standard D903-2004. Rectangular (304.8 mm×25.4 mm) specimens (10 replicates) were cut from a production sheet in the machine direction (MD) or cross direction (CD). The test speed was 305 mm/min. The peel tests were performed on samples without environmental aging (under ambient conditions) or after environmental aging according to ASTM D1183 condition B (with high/low temperature and humidity ramp for a total of 7 days). If the skin materials cannot be separated from core, the results can be reported as “peel cannot be initiated”.

Peel could not be initiated under ambient conditions or after environmental aging. No blistering or bubbling was observed on the film surfaces after the environmental aging.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, configurations, examples and embodiments have been described above, it will be recognized by the person of ordinary skill in the art, given the benefit of this disclosure, that additions, substitutions, modifications, and alterations of the disclosed illustrative aspects, configurations, examples and embodiments are possible.

1. An in-line process of producing a thermoplastic composite article using an in-line system, the in-line process comprising:
combining reinforcing materials and a thermoplastic material in an aqueous solution;
disposing the aqueous solution with the combined reinforcing materials and the thermoplastic material onto a moving support;
removing water from the disposed aqueous solution on the moving support to form a web comprising open cell structures formed from the reinforcing materials and the thermoplastic material;
drying the web on the moving support to provide a porous core layer;
heating the dried, porous core layer on the moving support to melt the thermoplastic material of the heated, porous core layer;
disposing a first skin layer on a first surface of the heated, porous core layer on the moving support, wherein the first skin layer comprises a printable surface; and
applying pressure to the heated, porous core layer comprising the disposed first skin layer to provide the thermoplastic composite article.

2. The in-line process of claim 1, further comprising printing a design onto the printable surface of the disposed first skin layer.

3. The in-line process of claim 1, further comprising disposing a second skin layer on a second surface of the heated, porous core layer on the moving support.

4. The in-line process of claim 1, further comprising adding a lofting agent to the aqueous solution with the combined reinforcing materials and the thermoplastic material.

5. The in-line process of claim 1, further comprising configuring the first skin layer as a film layer.

6. The in-line process of claim 5, wherein the film layer comprises reinforcement.

7. The in-line process of claim 5, wherein the film layer comprises one or more of a polyolefin and a polyester.

8. The in-line process of claim 1, wherein the thermoplastic material comprises a polyolefin and the reinforcing materials comprise inorganic fibers.

9. The in-line process of claim 2, wherein the printing comprises printing the design using a digital image and a digital printer.

10. The in-line process of claim 9, further comprising curing the printed design.

11. An in-line process of producing a thermoplastic composite article using an in-line system, the in-line process comprising:
combining reinforcing materials and a thermoplastic material in an aqueous solution;
disposing the aqueous solution with the combined reinforcing materials and the thermoplastic material onto a moving support;
removing water from the disposed aqueous solution on the moving support to form a web comprising open cell structures formed from the reinforcing materials and the thermoplastic material;
drying the web on the moving support to provide a porous core layer;
heating the dried, porous core layer on the moving support to melt the thermoplastic material of the heated, porous core layer;
disposing a first skin layer on a first surface of the heated, porous core layer on the moving support, wherein the first skin layer comprises a printable surface; and
printing a design onto the printable surface of the first skin layer to provide the thermoplastic composite article.

12. The in-line process of claim 11, further comprising disposing a second skin layer on a second surface of the heated, porous core layer on the moving support.

13. The in-line process of claim 11, further comprising adding a foam to the aqueous solution with the combined reinforcing materials and the thermoplastic material.

14. The in-line process of claim 11, further comprising adding a lofting agent to the aqueous solution with the combined reinforcing materials and the thermoplastic material.

15. The in-line process of claim 11, further comprising configuring the first skin layer as a film layer.

16. The in-line process of claim 15, wherein the film layer comprises reinforcement.

17. The in-line process of claim 15, wherein the film layer comprises one or more of a polyolefin and a polyester.

18. The in-line process of claim 11, wherein the thermoplastic material comprises a polyolefin and the reinforcing materials comprise inorganic fibers.

19. The in-line process of claim 11, wherein the printing comprises printing the design using a digital image and a digital printer.

20. The in-line process of claim 19, further comprising curing the printed design.

21-83. (canceled)
